(19) United States
(12) Patent Application Publication
(10) Pub. No.: US 2026/0006423 A1
(43) Pub. Date: Jan. 1, 2026

(54) Emergency Messaging

(71) Applicant: RAPIDSOS, INC., New York, NY (US)

(72) Inventor: John Robert Katt, New York, NY (US)

(21) Appl. No.: 19/251,656

(22) Filed: Jun. 26, 2025

Related U.S. Application Data
(60) Provisional application No. 63/664,584, filed on Jun. 28, 2024.

(51) Int. Cl. H04W 4/90; G08B 25/00; G08B 25/01; H04L 51/046

(52) U.S. Cl. CPC H04W 4/90; G08B 25/009; G08B 25/014; H04L 51/046

(57) ABSTRACT

An emergency management cloud server operative to be communicatively coupled to a user device and to a plurality of emergency service provider (ESP) terminals at a plurality of ESPs, the emergency management cloud server configured to: identify a user in an emergency, the user associated with the user device; obtain a location of the emergency, the location generated by the user device; determine an ESP, from the plurality of ESPs, that can provide an emergency response to the location based on the location being within a service area of the ESP; provide a prompt at an ESP terminal of the ESP to initiate communication with the user device via the emergency management cloud server; receive an input from the ESP terminal in response to the prompt; and initiate a real time messaging session between the user device and the ESP terminal in response to the input.

### CROSS-REFERENCE TO RELATED APPLICATIONS

The present application claims priority to U.S. Provisional Patent Application No. 63/664,584, filed Jun. 26, 2024, entitled “EMERGENCY MESSAGING” which is hereby incorporated by reference herein in its entirety, and which is assigned to the same assignee as the present application.

### FIELD OF THE DISCLOSURE

The present disclosure relates generally to enhanced 9-1-1 (E911) and next generation 9-1-1 emergency services, and more particularly to methods and apparatuses for real time messaging with emergency services.

### BACKGROUND

A person in an emergency situation may request help using a mobile communication device such as a cell phone to dial a designated emergency number like 9-1-1 or a direct access phone number for the local emergency service provider (e.g. an emergency dispatch center). Many emergency service providers have upgraded their systems to move toward next generation emergency response technologies (e.g., Next Generation 911 technologies, or “NG911”). However, the adoption rates of these next generation emergency response technologies vary from emergency service provider to emergency service provider, due to differences in funding, jurisdiction, and system architecture, and therefore many emergency service providers are unable to receive emergency text messages.

### BRIEF DESCRIPTION OF THE DRAWINGS

FIG. 1 is a diagram of an emergency management cloud server in accordance with an embodiment.

FIG. 2 illustrates a graphical user interface (GUI) provided by an emergency response application, in accordance with some embodiments.

FIG. 3A and FIG. 3B depict systems and processes for receiving and transmitting emergency data from and to an emergency management cloud server, respectively, in accordance with some embodiments.

FIG. 4 is a block diagram of an emergency service provider (ESP) in communication with an emergency management cloud server, in accordance with some embodiments.

FIG. 5 is a diagram of an ESP in communication with an emergency management cloud server, in accordance with some embodiments.

FIG. 6 illustrates an example GUI provided by an emergency response application, in accordance with some embodiments.

FIG. 7 illustrates an example GUI provided by an emergency response application, in accordance with some embodiments.

FIG. 8 illustrates an example GUI provided by an emergency response application for initiating a real time messaging session, in accordance with some embodiments.

FIGS. 9A & 9B illustrate examples of a GUI of a real time messaging session on a mobile device of the user in an emergency or an emergency responder, in accordance with some embodiments.

FIG. 10 illustrates an example of GUI provided by an emergency response application after terminating a real time messaging session, in accordance with some embodiments.

FIGS. 11A & 11B illustrate GUI examples during a termination protocol on an emergency response application accessible at an emergency service provider and a mobile device of the user in an emergency, respectively, in accordance with some embodiments.

FIG. 12 illustrates an example GUI provided by an emergency response application showing messaging status, in accordance with some embodiments.

FIGS. 13A & 13B illustrate example GUIs during termination of a real time messaging session at an emergency response application accessible at an emergency service provider, in accordance with some embodiments.

FIGS. 14A & 14B illustrate example GUIs showing a real time messaging session at an emergency response application accessible at an emergency service provider, in accordance with some embodiments.

FIG. 15 illustrates an embodiment of GUI provided by an emergency response application for an ESP user to start a communication channel with a user device.

FIG. 16 illustrates an example GUI provided by an emergency response application for an ESP user to confirm the location of the user device.

FIG. 17 illustrates an example GUI provided by an emergency response application for sending a multimedia request to a user device.

FIG. 18 illustrates an example GUI provided by an emergency response application for accessing recordings and archives of emergency calls and emergency messages.

### DETAILED DESCRIPTION

Briefly, the present disclosure provides apparatuses and methods for establishing real time messaging sessions between a user device (i.e. a mobile device or mobile phone) and an emergency service provider (ESP) terminal, or ESP mobile device. One example of an ESP is a public safety access point (PSAP) that receives emergency calls and dispatches responders such as police, paramedics, fire department, etc. Among other advantages, the disclosed apparatuses and methods provide real time messaging sessions between emergency callers and ESP operators for ESPs that do not have the capability to receive text-to-911 messages. Examples of “real time message sessions” include instant messaging (IM) and chat, such as but not limited to rich communication service (RCS) chat, internet relay chat (IRC), and the like, in which all participants are online and receive and respond to immediate messages. Another feature of real time messaging session is a status indication, such as but not limited to an indication that a participant is typing, online, etc.

One aspect of the present disclosure provides an emergency management cloud server operative to be communicatively coupled to a user device and to a plurality of emergency service provider (ESP) terminals at a plurality of ESPs. The emergency management cloud server is configured to: identify a user in an emergency, where the user is associated with the user device; obtain a location of the emergency, where the location is generated by the user device; determine an ESP, from the plurality of ESPs, that can provide an emergency response to the location based on the location being within a service area of the ESP; provide a prompt at an ESP terminal of the ESP to initiate communication with the user device via the emergency management cloud server; receive an input from the ESP terminal in response to the prompt; and initiate a real time messaging session between the user device and the ESP terminal in response to the input.

The emergency management cloud server may be further configured to: initiate the real time messaging session in response to receiving a confirmation from the user device. The emergency management cloud server may be further configured to: receive a location confirmation from the user device; and initiate the real time messaging session in response to receiving the location confirmation. The emergency management cloud server may be further configured to: provide an emergency response application instance to the ESP terminal via a web browser executed by the ESP terminal; receive a control input from the emergency response application instance; and initiate the real time messaging session in response to receiving the control input. The emergency management cloud server of may be further configured to: receive a phone number for the user device from the ESP terminal; and initiate a real time messaging session in response to receiving the phone number. The emergency management cloud server may be further configured to: initiate the real time messaging session using a preformatted message. The emergency management cloud server may be further configured to: provide the user device with selectable pre-formatted responses to an initial message sent to the user device. The emergency management cloud server may be further configured to: provide to the ESP terminal an activity level from the user device after the ESP terminal has sent a message to the user device, the activity level selected from the list consisting of: last seen, sent, read receipt, and typing. The emergency management cloud server may be further configured to: re-initiate the real time messaging session between the ESP terminal and the user device. The emergency management cloud server may be further configured to: prevent the user device from re-initiation of the real time messaging session after termination. The emergency management cloud server may be further configured to: enable the ESP terminal to terminate the real time messaging session; and initiate a close of session protocol in response to termination. The emergency management cloud server may be further configured to: terminate the real time messaging session in response to expiration of a timeout. The emergency management cloud server, may be further configured to: terminate the real time messaging session in response to a timeout configurable to be between one to ten minutes duration. The emergency management cloud server may be further configured to: extend the duration in response to input received from the ESP terminal. The emergency management cloud server may be further configured to: provide an indication to the ESP terminal when a text-to-911 message is sent from a user device to an ESP corresponding to the ESP terminal, the indication configurable by the ESP terminal via an on-off toggle. The emergency management cloud server may be further configured to: provide a status of the real time messaging session to the ESP terminal in an emergency queue, the status consisting of options: active and closed. The emergency management cloud server may be further configured to: provide the status in the emergency queue in response to initiation of the real time messaging session. The emergency management cloud server may be further configured to: remove an entry in the emergency queue corresponding to the real time messaging session in response to termination of the real time messaging session. The emergency management cloud server may be further configured to: receive an input from the ESP terminal; and remove an entry in the emergency queue corresponding to the real time messaging session in response to the input. The emergency management cloud server may be further configured to: display the real time messaging session to appear as a message type selected from message types consisting of: a short-message-service (SMS) message exchange, a multi-media message service (MMS) message exchange, and a rich communication services (RCS) message exchange, when the ESP corresponding to the ESP terminal does not have text-to-911 capability. The emergency management cloud server may be further configured to: establish the real time messaging session between the ESP terminal and the user device wherein the user device is enabled to utilize rich communication services (RCS). The emergency management cloud server may be further configured to: determine a language of a real time message received by the ESP terminal and sent by the user device; translate the real time message received by the ESP terminal into a preferred language; and translate further real time messages sent from the ESP terminal from the preferred language to the language determined for the real time messages received by the ESP terminal. The emergency management cloud server may be further configured to: translate messages of a real time messaging session sent from the ESP terminal to the user device. The emergency management cloud server may be further configured to: translate messages of a real time messaging session in response to an emergency. The emergency management cloud server may be further configured to: send recorded voice messages during the real time messaging session, where the recorded voice messages comprise recorded voice notes. The emergency management cloud server may be further configured to: play an audio file of a recorded voice message from the user device at the ESP terminal during the real time messaging session. The emergency management cloud server may be further configured to: receive an emergency alert from a monitoring center on behalf of a user of the user device. The emergency management cloud server o may be further configured to: initiate the real time messaging session as a three-way real time chat between the user device, the monitoring center, and the ESP terminal.

Another aspect of the present disclosure is a method for facilitating communications between a user in an emergency and an emergency service provider (ESP), by an emergency management cloud server. The method includes: identifying a user in an emergency, where the user associated with a user device; obtaining a location of the emergency, where the location is generated by the user device; determining an ESP, from a plurality of ESPs, that can provide an emergency response to the location based on the location being within a service area of the ESP; providing a prompt at an ESP terminal to initiate communication with the user device via the emergency management cloud server; receiving an input from the ESP terminal; and initiating a real time messaging session between the user device and the ESP terminal.

The method may further implement: initiating the real time messaging session in response to receiving a confirmation from the user device. The method of may further implement: receiving a location confirmation from the user device; and initiating the real time messaging session in response to receiving the location confirmation. The method may further implement: enabling the ESP terminal to terminate the real time messaging session; and initiating a close of session protocol in response to termination. The method may further implement: displaying the real time messaging session to appear as a message type selected from the message types consisting of: a short-message-service (SMS) message exchange, a multi-media message service (MMS) message exchange, and a rich communication services (RCS) message exchange when the ESP corresponding to the ESP terminal does not have text-to-911 capability. The method may further implement: providing a status of the real time messaging session to the ESP terminal in an emergency queue, the status consisting of options: active and closed. The method may further implement: providing the status in the emergency queue in response to initiation of the real time messaging session. The method may further implement: removing an entry in the emergency queue corresponding to the real time messaging session in response to termination of the real time messaging session. The method may further implement: receiving an input from the ESP terminal; and removing an entry in the emergency queue corresponding to the real time messaging session in response to the input. The method may further implement: re-initiating the real time messaging session between the ESP terminal and the user device by the ESP terminal. The method may further implement: providing an indication to the ESP terminal when a text-to-911 message is sent from a user device to an ESP corresponding to the ESP terminal, the indication configurable by the ESP terminal via an on-off toggle.

Another aspect of the present disclosure is a processor, and a non-volatile, non-transitory memory operatively coupled to the processor and executable instructions stored in the non-volatile, non-transitory memory, executable by the processor, that when executed cause the processor to be operative to: provide a graphical user interface (GUI) to an emergency service provider (ESP) terminal, the GUI operative to facilitate real time messaging between the ESP terminal and a user device during an emergency, the GUI comprising: an emergency queue with emergency calls and emergency alerts received by the ESP; a communication interface operative to send two-way messages and multimedia files during a real time messaging session; and an interactive map depicting a location of an emergency and situational awareness information for responding to the emergency.

The processor, may be further operative to: display the real time messaging session to appear as a message type selected from the list of message types consisting of: an short-message-service (SMS) message exchange, a multi-media message service (MMS) message exchange, and a rich communication services (RCS) message, when the ESP corresponding to the ESP terminal does not have text-to-911 capability. The processor, may be further operative to: provide a status of a real time messaging session in an emergency queue, the status selected from options consisting of: active and closed. The processor, may be further operative to: provide an indication of a real time messaging session in the emergency queue. The processor, may be further operative to: remove a real time messaging session from the emergency queue in response to termination of the real time messaging session.

In another aspect, a system for communications between a user in an emergency and an emergency service provider (ESP), includes: (a) a user device with messaging capability; (b) an emergency response platform accessible by an ESP user at an ESP terminal at the ESP; and (c) an emergency management cloud server communicatively coupled to the user device and the ESP terminal via the emergency response platform and configured to: (i) identify the user in an emergency associated with the user device; (ii) obtain the location of the emergency generated on the user device; (iii) determine the ESP that can provide emergency response to the location of the emergency as the location falls within the service area of the ESP; (iv) prompt the ESP user at the ESP to initiate communication with the user via emergency response platform; (v) receive input from the ESP user; and (vi) initiate a real time messaging session between the user and the ESP user. In some embodiments, the real time messaging session is initiated after the user has confirmed the emergency. In some embodiments, the real time messaging session is initiated after the user has confirmed the location of the emergency. In some embodiments, the ESP user initiates the real time messaging session to the user in the emergency by pressing a button on the emergency response application accessible via a web portal accessed at the terminal of the ESP, wherein the emergency message is a text back message. In some embodiments, the ESP user initiates the real time messaging session to the user by entering a phone number. In some embodiments, the ESP user chooses a preformatted message for initiating the real time messaging session. In some embodiments, the user is provided with pre-formatted responses to choose from in the real time messaging session. In some embodiments, the ESP user is provided an indication of the activity level of the user after sending the emergency message, wherein the activity level comprises one or more of last seen, sent, read receipt, typing, etc. In some embodiments, the ESP user has ability to re-initiate the real time messaging session with the user seamlessly. In some embodiments, the user is not provided with ability re-initiate the real time messaging session after termination. In some embodiments. the ESP user can terminate the real time messaging session and an automated close of session protocol is initiated. In some embodiments, the real time messaging session is terminated by expiration of a timeout. In some embodiments, the timeout is set to 1-10 minutes and the timeout is extended based on input from the ESP user. In some embodiments, the user has sent a text-to-911 message to the ESP and the visual indication of the alert is indicated with a blinking visualization or sound notification to alert the ESP user, wherein the blinking visualization or sound notification can be turned off. In some embodiments, the status of the real time messaging session is indicated in a queue of emergency alerts or emergency calls, wherein the status comprises active and closed. In some embodiments, the initiation of the real time messaging session is indicated on the queue of emergency alerts or emergency calls. In some embodiments, the termination of real time messaging session also automatically removes associated alert from the queue. In some embodiments, the termination of real time messaging session also removes associated alert from the queue after input from the ESP user. In some embodiments, the two-way messaging session has the appearance of an SMS message exchange, MMS message exchange, or an RCS message exchange. In some embodiments, the messaging capability of the user device is RCS enabled. In some embodiments, the real time messaging session is translated after language determination. In some embodiments, the real time messaging session can be translated only for the ESP user. In some embodiments, the real time messaging session can be translated only for the user in an emergency. In some embodiments, the real time messaging session comprises of IVR messages, or audio messages, transcribed from voice notes (voice-to-text, text-to-voice, etc.) from the user or the ESP user. In some embodiments, the real time messaging session comprises messages from the user or the ESP user that are read out loud. In some embodiments, the real time messaging session further comprises an operator at a monitoring center who has initiated an emergency alert on behalf of the user. In some embodiments, the real time messaging session further comprises initiating a three-way real time chat between the user, the operator at the monitoring center and the ESP.

In some aspects, disclosed herein are methods for facilitating communications between a user in an emergency and an emergency service provider (ESP), by an emergency management cloud server, the method comprising: (i) identify the user in an emergency associated with the user device; (ii) obtain the location of the emergency generated on the user device; (iii) determine the ESP that can provide emergency response to the location of the emergency as the location falls within the service area of the ESP; (iv) prompt the ESP user at the ESP to initiate communication with the user via emergency response platform; (v) receive input from the ESP user; and (vi) initiate a real time messaging session between the user and the ESP user. In some embodiments, the real time messaging session is initiated after the user has confirmed the emergency. In some embodiments, the real time messaging session is initiated after the user has confirmed the location of the emergency. In some embodiments, the ESP user can terminate the real time messaging session and an automated close of session protocol is initiated. In some embodiments, the real time messaging session appears to be an SMS message exchange, an MMS message exchange, or an RCS message exchange with the ESP, wherein the ESP does not have capability to accept text-to-911. In some embodiments, a status of the real time messaging session is indicated in a queue of emergency alerts or emergency calls, wherein the status comprises active and closed. In some embodiments, the initiation of the real time messaging session is indicated on the queue of emergency alerts or emergency calls. In some embodiments, the termination of real time messaging session also automatically removes associated alert from the queue. In some embodiments, the termination of real time messaging session also removes associated alert from the queue after input from the ESP user. In some embodiments, the cloud server provides the ESP user with the capability to re-initiate the real time messaging session, but not to the user. In some embodiments, the user has sent a text-to-911 message to the ESP and the visual indication of the alert is indicated with a blinking visualization or sound notification to alert the ESP user, wherein the blinking visualization or sound notification can be turned off.

In some aspects, disclosed herein are a graphical user interface (GUI) accessible from an emergency service provider (ESP) by an ESP user for communicating with a user in an emergency comprising: (a) an emergency queue comprising emergency calls and emergency alerts received by the ESP; (b) a communication interface for sending two-way messages and multimedia file comprising a real time messaging session; and (c) an interactive map depicting the location of the emergency and situational awareness information for responding to the emergency. In some embodiments, the two-way appears to be an SMS message exchange, an MMS message exchange, or an RCS message exchange with the ESP, wherein the ESP does not have capability to accept text-to-911. In some embodiments, a status of the real time messaging session is indicated in a queue of emergency alerts or emergency calls, wherein the status comprises active and closed. In some embodiments, the initiation of the real time messaging session is indicated on the queue of emergency alerts or emergency calls. In some embodiments, the termination of real time messaging session also automatically removes associated alert from the queue.

Disclosed herein are systems, devices, media, and methods for providing enhanced emergency communications and functions. The disclosed systems, devices, media and methods, among other things, take advantage of technological advancements that have allowed for mobile communication devices to generate accurate locations by incorporating multiple technologies embedded in the devices, such as GPS, Wi-Fi, and Bluetooth to create device-based hybrid locations. Device-based hybrid locations are locations calculated on an electronic or communication device, as opposed to locations calculated using a network (e.g., a carrier network). Device-based hybrid locations (also, referred to as supplemental location) can be generated using GPS, network-based technologies, Wi-Fi access points, Bluetooth beacons, barometric pressure sensors, dead reckoning using accelerometers and gyrometers, and a variety of crowdsourced and proprietary databases that device operating systems providers are running to enhance location technology. These device-based hybrid locations can be quickly generated during emergency calls. Furthermore, mobile communication devices (e.g., mobile phones, wearables, IoT devices, smart home devices, vehicle computers, cameras, etc.) are often capable of generating or storing additional information that may be useful in responding to emergency situations, such as health data or medical histories.

In some cases, primary location, i.e, an automatic location identification (ALI) is shared during an emergency call (such as a 911 call in the US) or a text-to-911 through an emergency network. The location data may include one or more of lat/long, z-direction/altitude, location accuracy, dispatchable location. The location data may be primary or supplementary location.

During an emergency, a modern mobile communication device may have access to other useful data, such as an implicated person's blood type, preexisting medical conditions, or even the implicated person's current heartrate. In some embodiments, the mobile communication device has access to data from sensors (e.g., health or environmental sensors). For example, a video feed of the emergency via a connected surveillance camera can provide situational awareness regarding the emergency.

In one aspect, disclosed herein is an emergency response data platform (cloud server) capable of receiving emergency data (e.g., device-based hybrid locations and additional emergency information, such as health data, medical emergencies, and multimedia data in the form of audio notes, images and video) from smart devices and systems (e.g., mobile phones, vehicular console, and IoT devices) and transmitting the emergency data to emergency service providers (ESPs) to assist the ESPs in responding to emergencies. However, while device-based hybrid locations are generally more accurate and more quickly generated than the locations estimated by wireless carriers (as mentioned above), device-based hybrid locations are generally only available for emergency calls made by mobile phones. Thus, because ESPs receive emergency calls from both mobile phone and landline phones, if the cloud server were to only provide device-based hybrid locations to an ESP, the cloud server would not be providing locations to the ESP for all of the emergency calls received by the ESP. Therefore, the cloud server is operative to source and ingest locations associated with landline phones that make emergency calls to ESPs, so that the cloud server can provide locations to an ESP for all of the emergency calls that the ESP receives. In another aspect, then, disclosed herein is an cloud server capable of receiving emergency data from smart devices and systems and emergency call data (e.g., data associated with emergency calls made to ESPs) and transmitting both the emergency data and the emergency call data to the ESPs to assist the ESPs in responding to emergencies.

### Cloud Server Platform

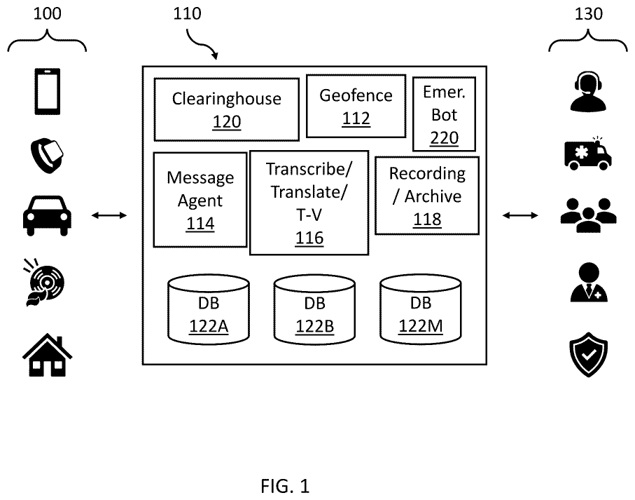

In various embodiments, disclosed herein are devices, systems, and methods for managing emergency data and emergency communications for more effective and efficient emergency response. FIG. 1 depicts a diagram of an emergency management cloud server 110 in accordance with one embodiment of the present disclosure. In one example, an emergency data source 100 transmits emergency to an emergency management cloud server 110 before, during, or after an emergency, and the emergency response data platform shares the emergency data with an emergency service provider (ESP) 130. The ESP 130 can then use the emergency data to more efficiently and effectively respond to corresponding emergencies. The emergency data source 100 may be a third-party server system (hereinafter, “third-party server”). For example, in some embodiments, the emergency data source 100 is a third-party server (e.g., a backend server system) of a technology company that produces software for electronic devices, such as Apple or Google. The emergency data source 100 may be an electronic device. For example, the emergency data source 100 may be a communication device (e.g., a walkie talkie or two-way radio, a mobile or cellular phone, a computer, a laptop, etc.), a wearable device (e.g., a smartwatch), or an Internet of Things (IoT) device such as a home assistant (e.g., an Amazon Echo) or a connected smoke detector (e.g., a Nest Protect smoke and carbon monoxide alarm). In some embodiments, an electronic device includes a display, a processor, a memory (e.g., an EPROM memory, a RAM, or a solid-state memory), a network component (e.g., an antenna and associated components, Wi-Fi adapters, Bluetooth adapters, etc.), a data storage, a user interface, an emergency alert program, one or more location components, and one or more sensors. In some embodiments, the processor is implemented as one or more microprocessors, microcomputers, microcontrollers, digital signal processors, central processing units, state machines, logic circuitries, and/or devices that manipulate signals based on operational instructions. Among other capabilities, the processor is configured to fetch and execute computer-readable instructions stored in the memory. The emergency management cloud server 110 comprises at least one processor, and non-volatile, non-transitory memory operatively coupled to the at least one processor. The non-volatile, non-transitory memory stores executable instructions (code) that are executable by the at least one processor to perform the methods of operation disclosed herein. The emergency management cloud server 110, processor, and non-volatile, non-transitory memory may all or each be distributed functions and that may operate in a cloud-based environment to provide instances of an emergency response application to multiple ESPs.

In some embodiments, the display is part of the user interface (e.g., a touchscreen is both a display and a user interface in that it provides an interface to receive user input or user interactions). In some embodiments, the user interface includes physical buttons such as an on/off button or volume buttons. In some embodiments, the display and/or the user interface comprises a touchscreen (e.g., a capacitive touchscreen), which is capable of displaying information and receiving user input. In some embodiments, the communication device includes various accessories that allow for additional functionality. In some embodiments, these accessories (not shown) include one or more of the following: a microphone, a camera, speaker, a fingerprint scanner, health or environmental sensors, a USB or micro-USB port, a headphone jack, a card reader, a SIM card slot, or any combination thereof. In some embodiments, the one or more sensors include, but are not limited to: a gyroscope, an accelerometer, a thermometer, a heart rate sensor, a barometer, or a hematology analyzer. In some embodiments, the data storage includes a location data cache and a user data cache. In some embodiments, the location data cache is configured to store locations generated by the one or more location components.

In some embodiments, the emergency alert program is a web application or mobile application. In some embodiments, the emergency alert program is configured to record user data, such as a name, address, or medical data of a user associated with the electronic device. In some embodiments, the emergency alert program is configured to detect when an emergency request is generated or sent by the electronic device (e.g., when a user uses the electronic device to make an emergency call). In some embodiments, in response to detecting an emergency request generated or sent by the electronic device, the emergency alert program is configured to deliver a notification to the cloud server 110. In some embodiments, the notification is an HTTP post containing information regarding the emergency request. In some embodiments, the notification includes a location (e.g., a device-based hybrid location) generated by or for the electronic device. In some embodiments, in response to detecting an emergency request generated or sent by the electronic device, the emergency alert program is configured to deliver user data to the cloud server 110.

In some embodiments, the emergency management cloud server 110 includes a cloud server operating system, a cloud server CPU (processor), an cloud server memory unit (non-volatile, non-transitory memory), an EMS communication element, and one or more software modules. In some embodiments, the cloud server CPU is implemented as one or more microprocessors, microcomputers, microcontrollers, digital signal processors, central processing units, state machines, logic circuitries, and/or devices that manipulate signals based on operational instructions. Among other capabilities, the cloud server CPU is configured to fetch and execute computer-readable instructions stored in the cloud server memory unit. The cloud server memory unit optionally includes any computer-readable medium known in the art including, for example, static random-access memory (SRAM) and dynamic random-access memory (DRAM), and non-volatile memory, such as read-only memory (ROM), erasable programmable ROM, flash memories, hard disks, optical disks, and magnetic tapes. The cloud server memory unit optionally includes modules, routines, programs, objects, components, data structures, etc., which perform particular tasks or implement particular abstract data types. The cloud server CPU may be a distributed CPU and the cloud server may be a distributed server.

In some embodiments, the cloud server 110 includes one or more cloud server databases, one or more servers, and a clearinghouse 120. In some embodiments, the clearinghouse 120, as described in further detail below, is an input/output (I/O) interface configured to manage communications and data transfers to and from the cloud server 110 and external systems and devices. In some embodiments, the clearinghouse 120 includes a variety of software and hardware interfaces, for example, a web interface, a graphical user interface (GUI), and the like. The clearinghouse 120 optionally enables the cloud server 110 to communicate with other computing devices, such as web servers and external data servers. In some embodiments, the clearinghouse 120 facilitates multiple communications within a wide variety of networks and protocol types, including wired networks, for example, LAN, cable, etc., and wireless networks, such as WLAN, cellular, or satellite. In some embodiments, the clearinghouse 120 includes one or more ports for connecting a number of devices to one another or to another server. In some embodiments, the clearinghouse 120 includes one or more sub-clearinghouses, such as location clearinghouse and additional data clearinghouse, configured to manage the transfer of locations and additional data, respectively. In some embodiments, the cloud server 110 additionally includes a user information module that receives and stores user information (e.g., personal information, demographic information, medical information, location information, etc.) within the cloud server 110. In some embodiments, users can submit user information through a website, web application, or mobile application, such as during a registration process for an emergency response application. In some embodiments, when the cloud server 110 receives emergency data including user information, such as through an emergency alert received by the clearinghouse 120 (as described below), the cloud server 110 stores the user information in the user information module. In some embodiments, user information stored within the user information module is received by the cloud server 110 from a third-party server system, as described above. In some embodiments, user information stored within the user information module is associated with an identifier of a user or an electronic device associated with a user, such as a phone number or an email address. APIs may be used to query data from the clearinghouse. For example, LIS App for querying location information and ADR App for querying additional data about an emergency. A query from an ESP agency may be received via such API and the response will be returned in response to the query and may be displayed within the GUI at the ESP.

As mentioned above, in some embodiments, the emergency management cloud server 110 shares an emergency alert including emergency data with an emergency service provider (ESP) 130. In some embodiments, an ESP 130 (e.g., a public safety answering point (PSAP)) is a system that includes one or more of a display, a user interface, at least one central processing unit or processor, a network component, an audio system, (e.g., microphone, speaker and/or a call-taking headset), and an ESP application (e.g., a computer program) such as a computer aided dispatch (CAD) program or an emergency call taking program (which may be provided by a customer premise equipment or CPE). In some embodiments, the ESP application is operatively coupled to a database of emergency responders, such as medical assets, police assets, fire response assets, rescue assets, safety assets, etc. In some embodiments, the ESP application is an emergency response application provided by the cloud server 110, as described below. In some embodiments, the ESP application is installed on a computing device at the ESP 130 and comprise one or more software modules, such as a call taking module, an ESP display module, a supplemental or updated information module, or a combination thereof. In some embodiments, the ESP application displays the information on a map (e.g., on the display). In some embodiments, the ESP application is accessible or executable on mobile devices associated with ESP 130, such as first responder devices. In some embodiments, the ESP application is an emergency response application provided by the cloud server 110, as described below.

### Emergency Databases

In some embodiments, as mentioned above with respect to FIG. 1, the emergency response data platform (cloud server) 110 includes a clearinghouse 120 (also referred to as an “Emergency Clearinghouse”) for receiving, storing, retrieving, and transmitting emergency data. In some embodiments, as depicted by FIG. 1, through the clearinghouse 120, the cloud server 110 can receive emergency data from an emergency data source 100 (as described above) and transmit the emergency data to an emergency data recipient, such as an emergency service provider (ESP) 130 (as described above). The emergency data that passes through the clearinghouse 120 may include (but is not limited to) location data (e.g., fixed addresses or device-based hybrid locations generated in real time) and additional data (e.g., medical history, personal information, or contact information, etc.). In some embodiments, through the clearinghouse 120, the cloud server 110 transmits emergency data to ESPs 130 to aid the ESPs 130 in responding to emergencies. For example, location data may allow emergency responders to arrive at the scene of an emergency faster, and additional data may allow emergency responders to be better prepared for the emergencies that they face.

The clearinghouse 120 may receive emergency data in various ways. For example, in some embodiments, an emergency data source 100 can unilaterally transmit emergency data to the clearinghouse 120. For example, in one embodiment, an emergency alert is triggered by an electronic device manually (e.g., in response to the selection of a soft or hard emergency button) or automatically based on sensor data received by the electronic device (e.g., smoke alarms). The electronic device can then transmit the emergency alert and any associated data to the cloud server 110, such as to an endpoint provided by the clearinghouse 120. Or, for example, in one embodiment, after an emergency alert is received by the cloud server 110 from a first emergency data source, the cloud server 110 can query a second emergency data source for emergency data (e.g., emergency data associated with the emergency alert received from the first emergency data source). For example, the emergency alert received from the first emergency data source may include a user identifier (e.g., a telephone number or an email address) for an owner or user of the first emergency data source. The cloud server 110 can then query the second emergency data source with the user identifier to retrieve additional emergency data associated with the owner or user of the first emergency data source. In some embodiments, emergency data received by the cloud server 110 is received in a format that is compatible with industry standards for storing and sharing emergency data. In some embodiments, the cloud server 110 formats emergency data that it receives into a format that is compatible with industry standards. For example, in some embodiments, the emergency data is formatted to be compatible with National Emergency Number Association (NENA) standards. In some embodiments, emergency data is formatted by the cloud server 110 to be compliant with the Presence Information Data Format Location Object (PIDF-LO) standard. In some embodiments, emergency data (or emergency call data, as described below) is formatted by the cloud server to be compliant with the Emergency Incident Data Object (EIDO) standard. In some embodiments, emergency data received by the cloud server 110 is stored within one or more databases 122. In some embodiments, emergency data received by the cloud server 110 is associated with one or more identifiers, such as a device or user identifier, e.g., a user name, a phone number, etc. In some embodiments, the databases 122 include a database of ESP agencies and details regarding the same including ESP name, location, login credentials, emergency and non-emergency numbers, ESP characteristics and capabilities (primary, secondary, text-to-911 capable, RCS capable, etc.), software integrations and messaging capabilities and preferences. In some embodiments, the databases 122 include a database of emergency responders, responder logins and contacts and associations with ESPs.

The clearinghouse 120 may share emergency data in various ways. For example, in some embodiments, an emergency data recipient, such as an ESP 130, can query the cloud server 110 for emergency data. For example, in some embodiments, an ESP 130 can query the cloud server 110 with an emergency data request including a user identifier (e.g., a telephone number or an email address) to receive emergency data gathered or received by the cloud server 110 associated with the user identifier. Or for example, an ESP 130 can query the cloud server 110 with a geospatial area to receive emergency data gathered or received by the cloud server 110 associated with the geospatial area. Alternatively, the cloud server 110 can autonomously transmit emergency data to an emergency data recipient without first receiving a query from the emergency data recipient (also referred to as “pushing” emergency data, as opposed to emergency data being “pulled” with a query). The cloud server 110 may push emergency data to an emergency data recipient using an emergency data subscription system. Using the emergency data subscription system, an emergency data recipient can subscribe to the clearinghouse 120 for a particular device identifier, user identifier, ESP account, or geospatial area. After subscribing to a subscription, the emergency data recipient may automatically receive updates regarding the subscription without first sending a query for emergency data. For example, if an ESP 130 subscribes to a phone number, whenever the cloud server 110 receives updated emergency data associated with the phone number, the clearinghouse 120 can instantly and automatically transmit the updated emergency data associated with the phone number to the ESP 130.

### Emergency Data Geofencing

A geofence system 112 may be applied to egress from the clearinghouse 120 or the cloud server 110 to protect sensitive emergency data from being shared with unintended recipients. For example, the geofence system 112 may check the authorization of a requesting agency to see if the emergency location is within the jurisdictional area of the requesting agency. As depicted in FIG. 1, in some embodiments, when emergency data (e.g., an emergency location or additional data) is received by the cloud server 110 from an emergency data source 100 (ingress data), the emergency data is first filtered via the geofence system 112 before being ingested by the clearinghouse 120 (not shown). When a query 117 for emergency data is received by the cloud server 110 from an emergency data recipient (e.g., an ESP 130), the query is processed by the geofence system 112 before response 119 emergency data is transmitted to the emergency data recipient. The query 117 comprising a user identifier (e.g., a phone number) is sent to a location app (e.g., LIS App), where the response comprising a location (e.g., a lat/lon, an address) of an emergency. Although not shown, queries may be sent to an additional data app (e.g., ADR app) for additional information (e.g., user data, medical data, sensor data) about an emergency.

As used herein, a geofence refers to a virtual perimeter that represents a real-world geographic area. A geofence can be dynamically generated—as in a radius around a point location—or a geofence can be a predefined set of boundaries (such as school zones or neighborhood boundaries). For emergency response, an emergency service provider (public or private entities) may be given jurisdictional authority to a certain geographical region or jurisdiction (also referred to as “authoritative regions”). In the context of emergency services, one or more geofences may correspond to the authoritative region of an ESP. In many cases, the ESP is a public entity such as a public safety answering point (PSAP) or a public safety service (PSS; e.g., a police department, a fire department, a federal disaster management agency, national highway police, etc.), which have jurisdiction over a designated area (sometimes, overlapping areas). Geofences are used to define the jurisdictional authority by various methods and in various Geographic Information System (GIS) formats. Geofences may only represent authoritative regions if the geofence has been assigned or verified by a local, state, or federal government. Geofences may represent assigned jurisdictions that are not necessarily authoritative regions. For example, a geofence is unilaterally created by its associated ESP without verification or assignment by a local, state, or federal government.

The cloud server 110 may maintain a geofence database including one or more geofences associated with each ESP 130 that is or has ever been communicatively coupled to the cloud server 110. A geofence may be associated with an ESP 130 may be submitted to the cloud server 110 by an administrator of the ESP 130, such as through an emergency response application (as described below) or via email. When emergency data is received by the cloud server 110 the cloud server 110 may identify a location associated with the emergency data (e.g., an emergency location included in an emergency alert) and determine if the location is within the combined authoritative jurisdiction (i.e., within any one of the geofences stored in the geofence database). If the location is not within the combined authoritative jurisdiction, the cloud server 110 rejects or drops the emergency data (also referred to as “ingress filtering”). When the cloud server 110 receives a query for emergency data from an ESP 130, the cloud server 110 may identify a geofence associated with the ESP 130 and return only emergency data associated with locations that are within the geofence associated with the ESP 130 (also referred to as “egress filtering). Geofences may be used in routing emergency data that is pushed to an emergency data recipient. For, example, an emergency data recipient may subscribe to a geofence. Then, when the cloud server 110 receives emergency data associated with a location that is within the geofence to which the emergency data recipient has subscribed, the cloud server 110 can instantly and automatically push the emergency data to the emergency data recipient.

### Emergency Response Application

Data and information may be shared between the emergency response data platform (cloud server) and an emergency service provider (ESP) through an emergency response application. As described in further detail below, the emergency response application may additionally be provided to an ESP to: a) facilitate communications between the ESP and an emergency caller (e.g., a person requesting emergency assistance) or b) facilitate communications between the ESP and one or more other ESPs. The emergency response application is a software application may either be installed on a computing device at the ESP or accessed via the internet through a web browser on the computing device (e.g., the emergency response application is hosted on a cloud computing system by the cloud server). The emergency response application may function to both facilitate a two-way communication link between the cloud server and the ESP and visualize data (e.g., emergency data) received by the ESP from the cloud server. The emergency response application may include various components, such as a frontend application (hereinafter “graphical user interface” or “GUI”), a backend application, an authorization module, and a user database. The emergency response application may additionally or alternatively include a credential management system or a geofence system (which may include or be otherwise communicatively coupled to a credentials database or a geofence database). The credential management system and the geofence system are external to the emergency response application and communicatively coupled to the emergency response application (e.g., the credential management system or geofence system can be housed or hosted on a cloud computing system by the cloud server). Any or all of the components of the emergency response application may be hosted on a cloud computing system by the cloud server, a computing device at an ESP, or some combination thereof.

The emergency response application may present a GUI as a webpage or web application that can be accessed through an internet or web browser. In that case, the emergency response application can be quickly and easily integrated into the systems used by emergency service providers (ESPs), such as public safety answering points (PSAPs), because accessing and using emergency response application requires no additional software or hardware outside of standard computing devices and networks. As previously discussed, one of the greatest hinderances that PSAPs face in providing emergency assistance to people experiencing emergency situations is in acquiring accurate locations of the emergencies and the people involved, because PSAPs are currently typically limited to verbally asking for and verbally receiving locations from callers. The clearinghouse is capable of receiving accurate locations (as well as additional emergency data, as described above) from electronic devices such as smartphones and delivering the accurate locations to the appropriate PSAPs during emergency situations. Therefore, it is advantageous to provide the emergency response application to PSAPs in the form of a webpage accessible through a standard web browser, in order to provide the potentially life-saving information stored within the clearinghouse to those capable of providing emergency assistance as quickly and easily as possible. However, the emergency response application may be a software application installed on a computing device at an ESP. The emergency response application may be provided by the cloud server or by a third-party.

The cloud server 110 may also include a messaging agent 114 for seamlessly interacting with various systems for message exchange. For example, the messaging agent 114 may be a rich business messaging agent for sending RCS messages, or other type of messaging agent or mechanism. The cloud server 110 may include a multimedia server/database 122M for receiving, storing, retrieving and archiving multimedia files including audio, video and image files sent via emergency messaging.

The cloud server 110 may include Transcribe/Translate/T-V module 116 operative for transcription, translation of emergency messages or converting the emergency messages from text-to-voice or voice-to-text. The EMCS may include language determination system (not shown) and separate translation system and transcription systems with access to large language models for machine learning and/or generative (AI) models, and various databases.

As shown in FIG. 1, a recording/archiving module 118 provides functionality needed for archiving of emergency messages, emergency call recordings, voice notes and other multimedia files. In addition, the cloud server 110 may include an emergency bot 220 which may interact with a user in an automated fashion. For example, the emergency bot 220 can automatically ask a user via text message or through Interactive Voice Response (IVR) to confirm that they are in need of emergency help. As this information is critical before an ESP call taker can take any actions. In some embodiments, the emergency bot 220 can automatically verify the emergency location in various ways including i) by prompting the use to confirm the location (may be saved on the account or received through other means); ii) prompting the user to provide the location by text or voice response; ii) prompting the user to share device-based hybrid location from the user device, etc. It is understood that the emergency bot can be trained or customized for each ESP and local rules and practices in that jurisdiction.

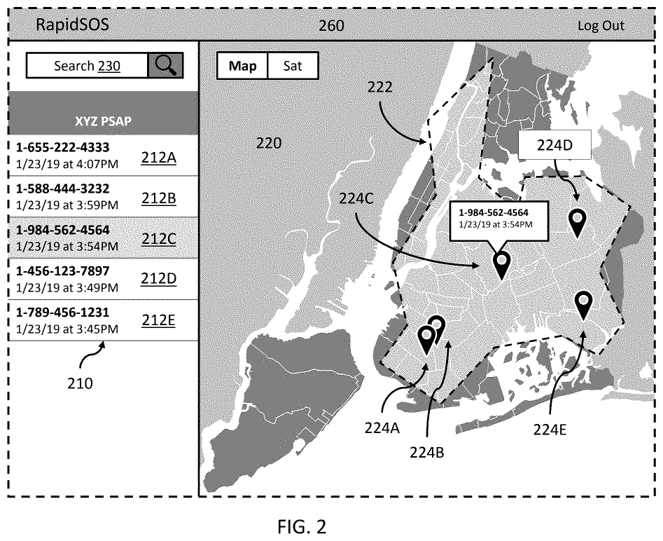

FIG. 2 illustrates an graphical user interface (GUI) 260 provided by an emergency response application. In some embodiments, the GUI 260 provides interactive elements that allow a user at an ESP to receive data from the cloud server, visualize data received from the cloud server, and transmit data to the cloud server. For example, in some embodiments, the GUI includes an entry field 230 through which a user can submit a device identifier, such as by typing or pasting the device identifier into the entry field 230. In some embodiments, by entering a number into the entry field 230, an ESP call taker may not retrieve any results. In some embodiments, the cloud server may enable the ESP call taker to then send an emergency message to the user's device with that phone number for sending an emergency message. In this way, an emergency message may be sent to number that is not in the call, text & alert queue 210. Traditionally, 911 call takers did not have ability to call or text to a phone number that is not in their queue. However, there can be a need to call or text to a number not in the queue for effective and efficient emergency response. It may be advantageous to call or text an alternate number or associated emergency contacts, when a caller is not responding or have lost their connection.

In some embodiments, after submitting a device identifier through the entry field 230, the user can prompt the emergency response application to generate and send an emergency data request by selecting a search button. The emergency response application 260 then generates an emergency data request including the device identifier and any other necessary information (e.g., a temporary access token) and transmits the emergency data request to the cloud server. The cloud server can then return any available emergency data associated with the device identifier to the emergency response application 260, as described above and below. In another example, in some embodiments, the emergency response application 260 can automatically receive emergency data from the cloud server for emergencies relevant to an ESP (e.g., emergencies located within the jurisdiction of the ESP) without requiring a user to generate an emergency data request, as described above and below. After receiving emergency data from the cloud server, the emergency response application 260 can then visualize the emergency data within the GUI of the emergency response application 260. For example, in some embodiments, the emergency response application 260 includes a list of incidents 210 and an interactive map 220, as illustrated by FIG. 2. As shown, an example display at a PSAP is depicted with two queues-one queue may show calls coming into the PSAP (“All Calls”) and another queue specific to the call taker/dispatcher position “My Calls.” In some embodiments, when the emergency response application 260 receives a location (e.g., an emergency location) and a device identifier associated with an emergency occurring within the jurisdiction 222 of the receiving ESP, the emergency response application 260 displays the location associated with the emergency within the interactive map 220 as a location marker 224 (also referred to as an “incident location”) and displays the device identifier associated with the emergency within the list of incidents 210 as an incident 212.

In addition to emergency locations, the emergency response application 260 can receive and visualize numerous types of emergency data from the cloud server. For example, the emergency response application 260 can receive additional data regarding an emergency, such as demographic or medical data associated with a person involved in the emergency (e.g., an emergency caller). In another example, the emergency response application 260 can receive data from sensors associated with the emergency, such as heartrate data collected by a sensor on an emergency caller's smartwatch. Or, for example, the emergency response application 260 can receive data regarding emergency response assets available for an emergency, as described below. In some embodiments, the emergency response application receives and visualizes messages received from emergency callers or other ESPs, as described below. The emergency response application can visualize any emergency data received from the cloud server within the GUI 260 of the emergency response application.

### Emergency Data Transmission

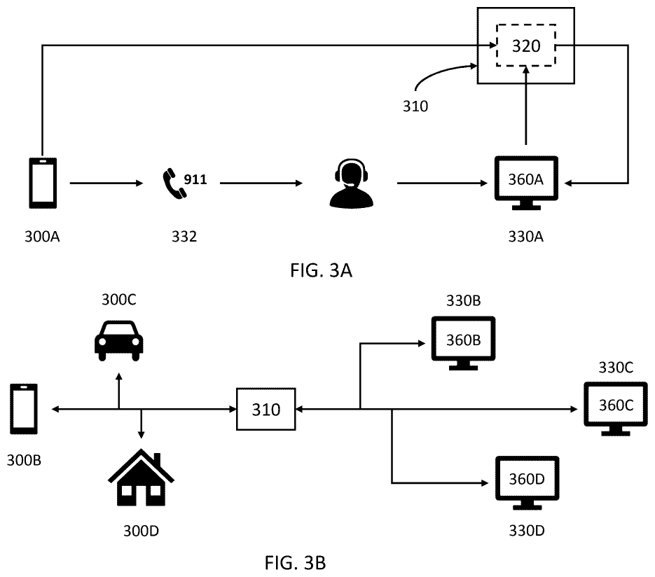

FIGS. 3A and 3B depict systems and processes for receiving and transmitting emergency data by an emergency management cloud server, in accordance with some embodiments of the present disclosure. As described above, in some embodiments, an emergency management cloud server maintains a clearinghouse that obtains and shares emergency data to aid emergency service providers (ESPs) in responding to emergencies via queries and responses as shown in FIG. 1. In another example, as depicted in FIG. 3A, during an emergency, an ESP 330A can send a query for emergency data (also referred to as an “emergency data request”) to the cloud server 310 (e.g., through an emergency response application 360A, as described above) for a particular emergency, and, in response, the cloud server 310 can send any available emergency data associated with the emergency back to the ESP 330A (such as through emergency response application 360A). In some embodiments, as described above, the emergency response application 360A includes an identifier associated with an emergency alert in the emergency data request. The cloud server 310 can then use the identifier associated with the emergency alert to retrieve emergency data associated with the emergency alert from the clearinghouse 320. For example, as described above, an ESP 340A (e.g., a public safety answering point (PSAP)) can receive an emergency alert in the form of a 9-1-1 phone call 332 (representative of an emergency or potential emergency) from a mobile phone 300A associated with a phone number (e.g., (555) 555-5555). The ESP 330A can then send an emergency data request including the phone number (i.e., the identifier associated with the emergency alert) to the cloud server 310, which can then retrieve any emergency data within the clearinghouse 320 associated with the phone number and return the available emergency data to the requesting ESP 330A. This process of returning emergency data to an ESP in response to an emergency data request is referred to as “pulling” emergency data from the clearinghouse.

As described above, in some embodiments, the emergency response data platform (cloud server) can “push” emergency data from the Emergency Clearinghouse to emergency service providers (ESPs), such as by using an emergency data subscription system (hereinafter, “subscription system”). FIG. 3B depicts a flow diagram of a process for pushing emergency data from the Emergency Clearinghouse to one or more ESPs. In some embodiments, a member of an ESP (e.g., a PSAP staff member) logs into the emergency response application 360B at an ESP system 330B (e.g., a computing device associated with the ESP) by accessing the emergency response application 360B (e.g., by navigating to the emergency response application 360B through a web browser) and submitting their login information through the GUI of the emergency response application 360B. In some embodiments, when the ESP member logs into the emergency response application 360B by submitting their login information, the emergency response application 360B or cloud server 310 then determines an ESP account ID associated with the ESP member's account and establishes a persistent or active communication link (e.g., a websocket connection) with the ESP system 330B, thereby automatically subscribing the ESP console to the ESP account ID for the duration of their login session. Then, as described above, when the cloud server 310 receives an emergency alert including a location (e.g., when an emergency call is made from an communication device 300B and sends an emergency alert to the cloud server 310 including a location generated by the communication device 300B), the cloud server 310 retrieves a geofence associated with every ESP registered with the cloud server 310 and determines if the location falls within any of the geofences. In response to determining that the location falls within a geofence associated with the ESP associated with the ESP account ID, the cloud server 310 then associates the location with the ESP account ID, determines if there are any active or persistent communication links between the cloud server 310 and any computing devices subscribed to the ESP account ID. In this instance, because the ESP system 330B is subscribed to the ESP account ID and actively linked to the cloud server 310 through the persistent or active communication link, the cloud server 310 automatically pushes (e.g., from the clearinghouse) the emergency alert or emergency data associated with the emergency alert (e.g., the location, a phone number, etc.) to the ESP system 330B for display within the emergency response application 360B. In some embodiments, emergency alerts or emergency data associated with emergency alerts that have been pushed to an ESP are displayed within a jurisdictional awareness view, as described below.

For example, ESP system 330B and ESP system 330C are two different ESP consoles associated with the same ESP (e.g., two computing devices at the same public safety answering point (PSAP)), PSAP A. ESP system 330D is associated with a second ESP, PSAP B. One day, PSAP call-takers access and successfully log into the emergency response application 360 (emergency response application 360D-360D) at each of the three ESP system (ESP systems 330B-330D), thereby establishing three separate active communication links, one active communication link between the cloud server 310 and each of the three ESP consoles. The ESP consoles are automatically subscribed by the cloud server 310 to the ESP account IDs associated with their respective ESPs (ESP ID A for PSAP A and ESP ID B for PSAP B). Both PSAP A and PSAP B are associated with only one geofence, geofence A and geofence B, respectively. Geofences A and B do not overlap. The geofences have previously been tagged within the cloud server 310 with their respective ESP account IDs (e.g., during a registration process for the emergency response application).

Later that day, an emergency call is made from communication device 300B, which causes communication device 300B to generate a first emergency alert including a first location of the communication device 300B and transmit the first emergency alert to the cloud server 310. When the cloud server 310 receives the first emergency alert, the cloud server 310 retrieves some or all of the geofences stored within the cloud server 310 and determines if the first location falls within any of the geofences stored within the cloud server 310. In this example, the cloud server 310 determines that the first location falls within geofence A, associated with PSAP A. In response, the cloud server 310 tags the first location with the ESP account ID associated with geofence A, ESP ID A. The cloud server 310 then determines if there are any active communication links between the cloud server and any ESP consoles subscribed to ESP ID A and automatically pushes (e.g., from the clearinghouse) the first emergency alert to those ESP consoles. In this example, both ESP system 330B and ESP system 330C are subscribed to ESP ID A, so the cloud server 310 automatically pushes the first emergency alert to both ESP system 330B and ESP system 330C for display within emergency response applications 360B and 360C, respectively, such as through a jurisdictional awareness view (as described below). The first location does not fall within geofence B, because geofence A and geofence B do not overlap, so the first emergency alert is not pushed to ESP system 330D, even though an active communication link has been established between the cloud server 310 and ESP system 330D.

Three minutes later, the cloud server 310 receives an emergency alert from electronic device 300D (e.g., a home security system) including a second location of the electronic device 300D. When the cloud server 310 receives the second emergency alert, the cloud server again retrieves some or all of the geofences stored within the cloud server 310 and determines if the second location falls within any of the geofences stored within the cloud server 310. In this example, the cloud server 310 determines that the second location falls within geofence B, associated with PSAP B. In response, the cloud server 310 tags the second location within the ESP account associated with geofence B, ESP ID B and automatically pushes the second emergency alert to ESP system 330D for display within emergency response application 360D, because ESP system 330D has an active communication link established with the cloud server 310 and ESP system 330D is subscribed to ESP ID B. The cloud server 310 does not push the second emergency alert to ESP system 330B or ESP system 330C. Although ESP system 330B and ESP system 330C have active communication links established with the cloud server 310, they are not subscribed to ESP ID B, and geofence A and geofence B do not overlap, meaning the second location does not fall within geofence A. Two minutes after that, the cloud server 310 receives an emergency alert from electronic device 300C (e.g., an intelligent vehicle system) including a third location of the electronic device 300C. The cloud server 310 determines that the third locations falls within geofence A (like the first location included in the first emergency alert) and thus automatically pushes the third emergency alert to both ESP system 330B and ESP system 330C for display within emergency response application 360B and 360C. In some embodiments, emergency response application 360B and emergency response application 360C display the first emergency alert and the third emergency alert simultaneously, such as through a jurisdictional awareness view, as described below.

### Jurisdictional Awareness View

In some embodiments, the systems, applications, servers, devices, methods, and media of the instant application provide a jurisdictional awareness view within the emergency response application. In some embodiments, the jurisdictional awareness view enables an ESP to view one or more ongoing or recently received emergency alerts (e.g., emergency calls) within one or more geofenced jurisdictions. FIG. 2 illustrates the jurisdictional awareness view displayed within the emergency response application, in accordance with one embodiment of the present disclosure. In some embodiments, the jurisdictional awareness view includes one or more lists of incidents 210 that displays one or more incidents 212 associated with one or more device identifiers (e.g., phone numbers, IP addresses). Here, the display includes two lists—one includes all calls received by an agency and another one is for the calls received by a particular position (which is a subset of all calls queue). In some embodiments, the jurisdictional awareness view additionally or alternatively includes an interactive map 220 that displays one or more incident locations 224 associated with the one or more incidents 212 associated with the one or more device identifiers, as described below. In some embodiments, the jurisdictional awareness view displays incidents and incident locations only for emergencies occurring within the jurisdiction 222 of the ESP at which the emergency response application 260 is being accessed.

For example, in the example illustrated in FIG. 2, an ESP has accessed an emergency response application 260 provided by the cloud server. In this example, the cloud server has pushed emergency data associated with five different emergency alerts to the ESP (as described above) through the emergency response application 260. Accordingly, the emergency response application 260 displays five different incidents 212 (e.g., incidents 212A-212E) within the list of incidents (also referred to as an incident queue) 210 and five corresponding incident locations 224 (e.g., incident locations 224A-224E) within the interactive map 262. As illustrated by FIG. 2, in some embodiments, incidents 212 and incident locations 224 may be selected or hovered over to highlight a particular incident 212. In this example, incident 212C and its corresponding incident location 224C have been selected and highlighted. In some embodiments, selecting a particular incident 212 or corresponding incident location 224 prompts the emergency response application 260 to display additional information associated with the particular incident 212 (e.g., additional emergency data or information associated with the emergency alert for which the particular incident 212 was created) within a single-incident view that displays only emergency data associated with the particular incident (as described below). Because the jurisdictional awareness view can show an ESP numerous incidents 212 occurring within the jurisdiction 222 of the ESP simultaneously, the jurisdictional awareness view can provide the ESP with situational awareness that the ESP otherwise would not have. For example, with the knowledge that incidents 212A and 212B originated in close proximity and at approximately the same time, an ESP personnel (e.g., a call taker at a public safety answering point) can determine that the two incidents may be related.

### Emergency Call Data Sharing

As described above, in various embodiments, an emergency response data platform (cloud server) receives and transmits emergency data (e.g., emergency locations, such as device-based hybrid locations) from various data sources (e.g., smart devices and systems) and to various data recipients (e.g., emergency service providers). In some embodiments, as mentioned above, the cloud server is additionally capable of sourcing and receiving emergency call data (e.g., data associated with emergency calls received by ESPs, as described below) and transmitting the emergency call data to ESPs along with relevant emergency data. By receiving emergency call data in addition to emergency data, and by transmitting both emergency call data and emergency data to an ESP, the cloud server is capable of providing emergency information (e.g., locations) to an ESP for all of the emergency calls received by the ESP, whether an emergency call received by the ESP is made by a mobile phone or a landline phone.

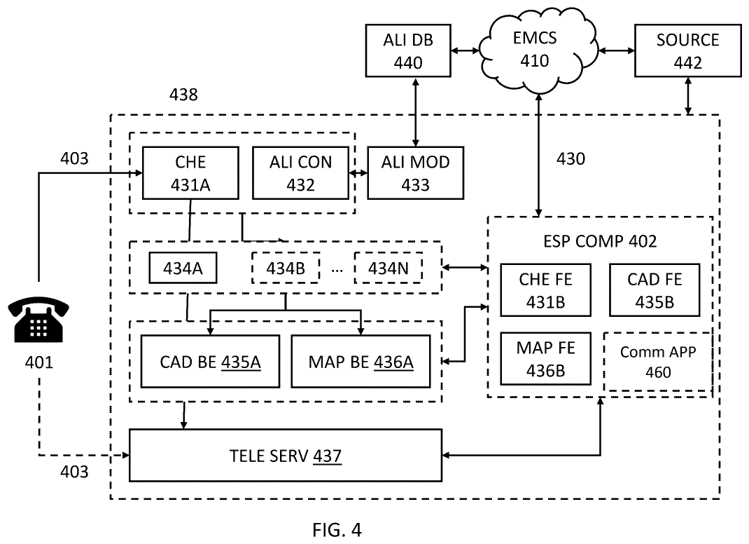

FIG. 4 depicts a diagram of an ESP in communication within an emergency management cloud server. As depicted in FIG. 4, in some embodiments, an ESP 430 includes call handling equipment (CHE) 431, an automatic location identification (ALI) controller 432, one or more ALI modems 433, one or more serial-to-ethernet converters (converters) 434, a computer aided dispatch (CAD) system 435, a mapping system 436, a telephony server 437, and one or more ESP computing devices 402. In some embodiments, some or all of the components of an ESP are communicatively coupled by an ESP network 438 (e.g., a hardline or wireless communication network). In some embodiments, the CHE 431 is combination of hardware and software systems configured to manage the receipt and handling of emergency calls routed to an ESP 430. In some embodiments, the CHE 431 includes a hardware component 431A and a frontend component (e.g., a user interface, which may include physical and digital components, such as a headset and a graphical user interface) CHE frontend 431B, which is executed on an ESP computing device 402. In some embodiments, the CHE hardware component 431A includes a backend software application. In some embodiments, the ALI controller 432 is a hardware or software system configured to manage the querying of an ALI database 440 for emergency call data and the receipt of emergency call data from the ALI database 440. In some embodiments, the CHE 431 and the ALI controller 432 are one unified system (e.g., the CHE 431 and the ALI controller 432 are built into a single piece of hardware). In some embodiments, an ALI modem 433 is a hardware system or device (e.g., a modem) through which the querying for and receipt of emergency call data from the ALI database 440 is made. In general, an ALI database is a secure database that contains hardcoded addresses (e.g., a street address) associated with hardline phones. In some embodiments, as described below, an ESP 430 queries an ALI database 440 (e.g., the ALI controller 432 transmits a query to the ALI database 440 through an ALI modem 433) when the ESP 430 receives an emergency call, in order to obtain the emergency caller's location.

In some embodiments, a serial-to-ethernet converter (converter) 434 (also referred to as a “port server”) is a hardware system or device that allows a serial port to communicate with an ethernet port. Because ALI feed into the agency and/or CHE systems typically output data through serial ports, and because CAD, mapping, and CHE frontend software systems are typically executed on hardware devices and systems that do not have or cannot receive serial inputs, converters 434 are typically necessary components of an ESP 430.

As described herein, a CAD system 435 is a system that facilitates and manages the dispatch of first responders, such as policemen, firemen, and emergency medical personnel. In some embodiments, a CAD system 435 includes a backend software system CAD backend 435A and a frontend software system CAD frontend 435B, which is executed on an ESP computing device 402. A mapping system 436 provides a visualization of emergency locations in relation to other landmarks or first responders through a map within a graphical user interface. In some embodiments, a mapping system 436 includes a backend software system mapping backend 436A and a frontend software system mapping frontend 436B, which is executed on an ESP computing device 402. In some embodiments, the CAD system 435 and the mapping system 436 are one unified system (e.g., the CAD system 435 and the mapping system 436 are programmed into a single software application).

In some embodiments, as depicted in FIG. 4, when an emergency call 403 is made from a hardline phone 401 and routed to an ESP 430, emergency call data, such as the audio component of the emergency call (hereinafter, “voice data”) and the phone number associated with the hardline phone, is first received by the CHE 431 (e.g., the CHE hardware component 431A). In some embodiments, the emergency call data is first received by the CHE 431 and the telephony server 437 in parallel. In some embodiments, after receiving the emergency call data, the CHE 431 then relays, forwards, or transmits the voice data to the telephony server 437, which is configured to relay the voice data to an ESP computing device 402. However, the emergency call data first received by the CHE 431 or the telephony server 437 does not include a location. To obtain a location associated with the hardline phone 401, the ALI controller 432 must then submit a query comprising the phone number associated with the hardline phone 401 to the ALI database 440, as described above. If the ALI database 440 includes a location (e.g., a hardcoded address, such as a street address) associated with the phone number (and therefore associated with the hardline phone 401), the ALI database 440 returns the location associated with the hardline phone 401 to the ALI controller 432. The CHE 431 can then relay (e.g., through an converter 434) the emergency call data, which now includes both the phone number associated with the hardline phone 401 and the location associated with the hardline phone 401, to the CAD system 435 (e.g., the CAD backend 435A), the mapping system 436 (e.g., the mapping backend 436A), and/or the CHE frontend 431B. Once the CHE 431 has relayed the emergency call data to the CAD system 435, the mapping system 436, and/or the CHE frontend component CHE fronted 431B, a telecommunicator can use an ESP computing device 402, which includes the CHE frontend 431B, the CAD frontend 435B, and the mapping frontend 436B, to respond to the emergency call (e.g., speaking to the emergency caller to determine the nature of the emergency, and then dispatching the appropriate first responders, if necessary).

In some embodiments, as described above, the emergency response data platform (cloud server) 410 provides an emergency response application (also referred to as Communicator App 460) that can be accessed via a web browser that can be executed on an ESP computing device 402. In some embodiments, as described above, the cloud server 410 receives emergency data from smart devices and systems and then provides relevant emergency data to appropriate ESPs 430. As described above, in many cases, when an emergency call is made to an ESP 430 by a mobile phone (e.g., an emergency call is made by the mobile phone and then routed to the ESP 430), the mobile phone transmits an emergency alert including a location generated by the mobile phone (e.g., a device-based hybrid location) to the cloud server 410. The cloud server 410 can then determine which ESP 430 should receive the emergency alert and/or the location generated by the mobile device, such as by using a geofencing or subscription system (as described above), and then transmit the emergency alert and/or the location generated by the mobile phone (as well as any other emergency data that the cloud server 410 may determine relevant to or associated with the emergency or the emergency alert) to the appropriate ESP 430, such as through the communicator application 460 accessed via the web browser executed on an ESP computing device 402. However, as mentioned above, ESPs 430 receive emergency calls from both mobile phones and hardline phones. If the cloud server 410 were to transmit only emergency data to an ESP 430, the cloud server 410 would not be transmitting emergency information to the ESP 430 for all of the emergency calls received by the ESP 430, only emergency calls received by the ESP 430 from mobile phones. Thus, it would be advantageous for the cloud server 410 to receive both emergency data and emergency call data and to share both emergency data and emergency call data with ESPs 430. In some embodiments, as illustrated in FIG. 4, the cloud server 410 is communicatively coupled to the ALI database 440 and can receive emergency call data directly from the ALI database 440, such as by transmitting a query comprising a phone number to the ALI database 440. In some embodiments, as illustrated in FIG. 4, the cloud server 410 is communicatively coupled to a third-party data source 442 that is communicatively coupled to the ESP 430, such that the third-party data source 442 can receive emergency call data from the ESP 430, and the cloud server 410 can receive the emergency call data from the third-party data source 442. However, in some embodiments, as described below, the cloud server 410 can receive emergency call data from an ESP 430 in various ways.

In some embodiments, the Communicator App 460 is configured to send and receive emergency messages (including text messages) from the user at the ESP. The user at the ESP may be a telecommunicator, a dispatcher, a supervisor, a specialist communicator, a first responder, etc. As described herein, the Communicator App 460 may have various capabilities including text-to-911, RCS, transcription, translation and AI processing for efficient and effective emergency response. In some embodiments, the Communicator App 460 may use various third party service providers to send, receive and process emergency messages.

### Emergency Data Broadcast Accessed by Emergency Response Application

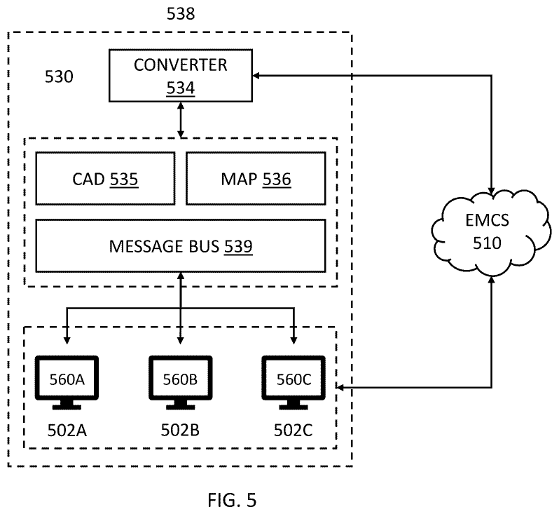

FIG. 5 depicts various systems and methods for an emergency management cloud server to source and receive emergency data (related to emergency messages and calls) from an emergency service provider (ESP). In some embodiments, the emergency management cloud server (EMCS) 510 can receive emergency call data received by an ESP 530 through an emergency response application 560 provided to the ESP 530 by the cloud server 510. For example, in some ESP implementations, after emergency call data is received by an ESP 530 and has been passed through an converter 534 (as described above) to a CAD system 535 and a mapping system 536, the emergency call data may be relayed (e.g., by the CAD system 535) to an ESP message bus 539 that is accessible to any or all devices on the ESP network 538 (the relaying of data to a message bus will be referred to hereinafter as “broadcasting”). Then, when an ESP computing device 502 (e.g, position number 1, 2 and 3) on the ESP network 538 is executing an instance of the emergency response application 560 provided by the cloud server 510, the cloud server 510 is also able to access the ESP message bus 539, through the emergency response application 560. In some implementations, the emergency response application 560 may include a browser plug-in, applet, or an executable file that is operative to monitor to the message bus 539 for emergency call data and provide the emergency call data to the cloud server 510 through the emergency response application 560 instance executing on the same ESP computing device 502 as the browser plug-in, applet or executable file. Thus, through the emergency response application 560, when it is executed on an ESP computing device 502 on the ESP network 538, the cloud server 510 is then able to receive emergency call data that is broadcasted over the ESP network 538 message bus 539. In some embodiments, an instance of the emergency response application 560 executed on an ESP computing device 502 on the ESP network 538 transmits emergency call data that has been broadcasted to the ESP message bus 539 to the cloud server 510 as soon as the emergency call data broadcasted on the ESP message bus 539 is detected or intercepted. In other words, the emergency response application 560 instance, and/or it's associated browser plug-in, applet or executable file, performs a packet sniffer operation to detect the relevant packets being broadcast on the message bus 539. An instance of the emergency response application 560 executing on an ESP computing device 502 may therefore detect and transmit emergency call data that has been broadcasted over the ESP message bus 539 periodically (e.g., once every five seconds). As depicted in FIG. 5, multiple instances of the emergency response application 560 can be executed on multiple respective ESP computing devices 502 (e.g., emergency response application instance 560A executed on ESP computing device 502A and emergency response application instance 560B executed on ESP computing device 502B, etc.). In some embodiments, when multiple instances of the emergency response application 560 are executed on multiple respective ESP computing devices 502 on an ESP network 538, all instances of the emergency response application 560 may transmit emergency call data that has been broadcasted to the ESP message bus 539 to the cloud server 510. In some embodiments, when multiple instances of the emergency response application 560 are executed on multiple respective ESP computing devices 502 on an ESP network 538, only one instance of the emergency response application 560 may transmit emergency call data that has been broadcasted to the ESP message bus 539 to the cloud server 510. In other words, only one emergency response application 560 instance may be configured to perform the packet sniffing operation to detect packets with emergency call data broadcast on the message bus 539. In some such embodiments, if a first instance of the emergency response application 560 that is transmitting emergency call data that has been broadcasted to the ESP message bus 539 to the cloud server 510 is closed, a second instance of the emergency response application 560 that is still being executed on an ESP computing device 502 on the ESP network 538 takes over the role of packet sniffing and will begin to detect and transmit emergency call data from the ESP message bus 539 to the cloud server 510, in replacement of the first instance of the emergency response application 560. Various ESP personnel (referred to as ESP user) such as ESP call taker, ESP dispatcher, ESP admin, etc., can login and access the emergency response application 560 via computer terminals 502A-C associated with specific position numbers.

### Intelligent Data Converter

In some embodiments, the cloud server 510 can receive emergency call data received by an ESP 530 from an intelligent converter, e.g., a serial-to-ethernet such as converter 534. For example, in some embodiments, a software or programming script can be added or otherwise integrated into the hardware and/or software of a converter 534 that includes instructions configured to prompt the converter 534 to transmit emergency call data received by an ESP 530 to the cloud server 510 when the emergency call data is passed through the converter 534. In some embodiments, the converter 534 duplicates the emergency call data and transmits the emergency call data to the cloud server 510. In some embodiments, the software or programming script is provided by the cloud server 510. In some embodiments, the software or programming script is integrated into the converter 534 before the converter 534 is installed at the ESP 530. In some embodiments, the software or programming script is provided to and integrated into the converter 534 remotely (e.g., through an internet connection). In some embodiments, the software or programming script is integrated into the converter 534 after the converter 534 is installed at the ESP 530. In some embodiments, the converter 534 includes a wireless communication component and transmits the emergency call data to the cloud server 510 through a cellular communication link. In some embodiments, the converter 534 transmits emergency call data to the cloud server 510 as soon as the emergency call data is passed through the converter 534. In some embodiments, the converter 534 transmits emergency call data to the cloud server 510 periodically (e.g., once every five seconds).

### Emergency Call Data Received Through Emergency Data Request

As described above, in some embodiments, the cloud server 510 maintains a clearinghouse of emergency data (also referred to as an “Emergency Clearinghouse”) and can receive queries for emergency data from ESPs 530 via e.g., LIS App (not shown). In some embodiments, as described above, a query for emergency data (also referred to as an “emergency data request”) includes a user identifier (e.g., a phone number, a name, an email address, an account number, user ID) that the cloud server 510 can use to identify emergency data (such as location or additional data) received by the clearinghouse that is associated with the user identifier. The cloud server 510 can then return the emergency data associated with the user identifier to the requesting ESP 530. In some embodiments, the cloud server 510 can receive emergency call data within a query from an ESP 530. For example, in some embodiments, when an ESP 530 transmits an emergency data request to the cloud server 510, the emergency data request includes emergency call data received by the ESP 530. The cloud server 510 can then ingest and/or store the emergency call data that was included in the emergency data request. In some embodiments, the ESP 530 transmits the emergency data request to the cloud server 510 through an ESP application (e.g., a CHE backend application or a CAD system 535) after the emergency call data is received by the ESP application (as described above). In some embodiments, the ESP 530 transmits an emergency data request including emergency call data to the cloud server 510 periodically (e.g., once every five seconds).

### Emergency Data and Emergency Text/Call/Alert Data

In some embodiments, after the cloud server has received emergency call data, emergency text, and emergency alerts data (e.g., through the emergency response application, from an intelligent converter, within an emergency data request, or through any other means), the cloud server can transmit the emergency call data to an ESP (e.g., for display within an emergency response application provided to the ESP by the cloud server). Herein, emergency call refers to a call made by a user in an emergency to an emergency number, such as 911 in the US and Canada and 112 in Europe. In some embodiments, an emergency text may include a text-to-911 message to emergency number in areas with text-to-911 coverage (i.e., the ESP serving that jurisdiction has ability to receive and support text-to-911 messages). In some embodiments, emergency texts may include SMS, MMS or RCS that is between users and ESP personnel for the emergency response. As used herein, an emergency alert may include various mechanisms to get emergency help. Specifically, an emergency alert may include a digital request for emergency response from users in an emergency, monitoring/call center on behalf of those users and emergency service providers such as PSAPs, and other agencies. The emergency call and text-to-911 can also generate an emergency alert, which may be provided as emergency alert with emergency data while the call and text arrives separately (often times, before the emergency call).

In some embodiments, before transmitting the emergency call data to an ESP, the cloud server converts the emergency call data from a first format into a second format. For example, in some embodiments, such as when the cloud server receives the emergency call data from a converter (as described above) or through an emergency response application executed on an ESP computing device on an ESP network to which the emergency call data has been broadcasted on an ESP message bus (as described above), the cloud server may receive the emergency call data as a raw or unprocessed text. In some embodiments, the cloud server then converts the emergency call data from raw or unprocessed text into formatted data that includes a plurality of data fields. In some embodiments, the cloud server converts the emergency call data from raw or unprocessed text into formatted data that is compliant with Emergency Incident Data Object (EIDO) standards. In some embodiments, the formatted data includes at least one phone number and at least one location associated with the at least one phone number. In some embodiments, such as when the cloud server receives the emergency call data within an emergency data request, the cloud server may receive the emergency call data as pre-formatted data. In some embodiments, when the emergency call data has been properly formatted (whether it was pre-formatted when it was received by the cloud server or formatted by the cloud server after it was received by the cloud server), the cloud server can then transmit the emergency call data to an ESP, as described below. In some embodiments, such as when an emergency response application executed on an ESP computing device on an ESP network accesses emergency call data that has been broadcasted to an ESP message bus, the emergency response application can format the emergency call data (if necessary) and display the emergency call data within the graphical user interface of the emergency response application (as described below) without first transmitting the emergency call data to the cloud server.

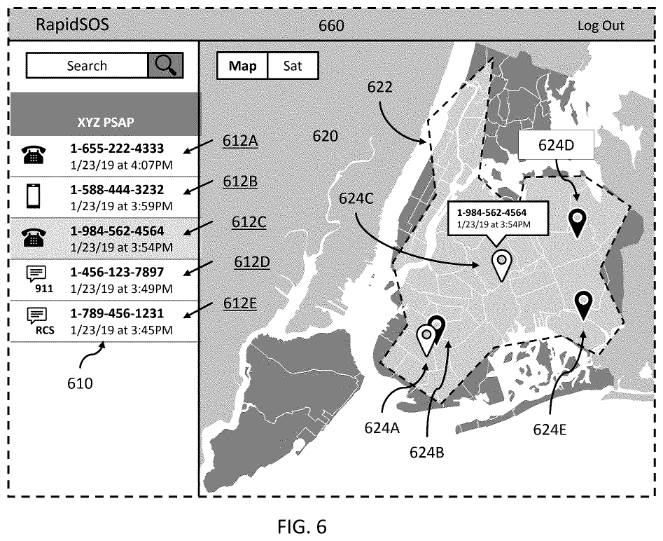

FIG. 6 depicts an example graphical user interface of an emergency response application 660 at an ESP (XYZ PSAP). As depicted, the application 660 includes a queue for calls, texts & alerts 610 and an interactive map 620. The calls in the queue (612A-E) are listed in a chronological order with the phone number and date and time information. The call, text & alerts queue 610 may contain various types of calls (type of service) or messaging including landline (depicted by telephone icon), mobile calls (depicted by mobile phone icon), text messages (depicted with 911 message icon), rich messaging (depicted with message with RCS), VoIP, sensor activated alerts, etc.

As depicted in the application 660, the location of each of these calls may be displayed in the interactive map 620 via location markers 624A-E may be visually indicated with a different visual appearance (here, landline calls shown with white location markers while mobile calls are shown with black location markers). The geofence of XYZ PSAP may be depicted via a jurisdictional boundary 622.

### Primary and Supplemental Emergency Data and Sources

In some embodiments, emergency data received by the emergency management cloud server (EMCS) that originates from, or is transmitted to the cloud server by, a government-sanctioned service (e.g., an ALI database, as described above) or a government-sanctioned organization (e.g., an emergency service provider, such as a public safety answering point, as described above) is referred to as “primary emergency data.” In some embodiments, a service or an organization that transmits primary emergency data to the cloud server is referred to as a “primary emergency data source.” In some embodiments, emergency data received by the cloud server that does not originate from, or is not transmitted to the cloud server by, a government-sanctioned service or organization (e.g., an electronic device or a device manufacturer) is referred to as “supplemental emergency data.” In some embodiments, a service or an organization that transmits supplemental emergency data to the cloud server is referred to as a “supplemental emergency data source.”

In some embodiments, a primary emergency data source is a publicly owned or operated service or organization. For example, in some embodiments, a primary emergency data source is a publicly owned or operated ALI database or a publicly owned or operated ESP. In some embodiments, a primary emergency data source is a privately owned or operated service or organization. For example, in some embodiments, a primary emergency data source is a privately owned or operated service or organization that gathers emergency data from ESPs, such as through hardware or software products provided to the ESPs by the privately owned or operated service or organization. Or for example, in some embodiments, a primary emergency data source is a privately owned or operated service or organization that gathers emergency data from publicly owned or operated services or organizations, such as an ALI database. Whether the primary emergency data source is a public or private service or organization, it is a primary emergency data source if it is a government-sanctioned service or organization, or if the emergency data that it receives and transmits to the cloud server originated from a government-sanctioned service or organization. For example, in some embodiments, the cloud server can receive emergency call data (as described above) directly from an ESP, such as through a broadcast accessed by an emergency response application (as described above), an intelligent converter (as described above), or an emergency data request (as described above). In such an example, the emergency call data received directly from the ESP is primary emergency data, and the ESP is a primary emergency data source. Or for example, in some embodiments, the cloud server can receive emergency call data (as described above) from a third-party data source (e.g., a private third-party data source, as described above) that is communicatively coupled to both the cloud server and an ESP, such that the third-party data source can receive emergency call data from the ESP and then transmit the emergency call data to the cloud server. In such an example, the emergency call data is primary emergency data, and the third-party data source is a primary emergency data source.

In general, because of procedural and liability considerations, it is important to differentiate primary emergency data from supplemental emergency data, especially when transmitting and displaying emergency data to emergency service providers (ESPs). In addition, there can be phase 1 and phase 2 location for wireless calls. For example, when dispatching first responders to an emergency location, an ESP may prefer (or be required) to dispatch first responders to an emergency location provided by a primary emergency data source (also referred to as a “primary location”), rather than an emergency location provided by a supplemental emergency data source (also referred to as a “supplemental location”), because the emergency location provided by the primary emergency data source originated from, or was transmitted by, a government-sanctioned service or organization. However, even though supplemental emergency data does or not originate from, or was not transmitted by, a government-sanctioned service or organization, supplemental emergency data can be just as helpful to an ESP in responding to an emergency, if not even more so. For example, as described above, in some instances, when an emergency call is made from a mobile phone, a location associated with the emergency may not be available to the ESP from a primary emergency data source. Or for example, as described above, in some instances, a primary emergency data source may only provide the ESP with the location of the cell tower facilitating the emergency call (also referred to as a “wireless phase one location” or a “phase one location”) or a triangulation of locations of multiple cell towers in communication with the mobile phone (also referred to as a “wireless phase two location” or a “phase two location”). A phase one location may be a mile away from the actual location of the mobile phone, or more; a phase two location may be a few hundred meters off. However, as described above, in some embodiments, when an emergency call is made from the mobile phone, a supplemental emergency data source (e.g., the mobile phone, or the device manufacturer of the mobile phone) transmits a device-based hybrid location generated by the mobile phone to the cloud server, and the cloud server can provide the device-based hybrid location to the ESP. A device-based hybrid location is typically no more than 5 or 10 meters away from the actual location of the mobile phone. Thus, in such an instance, while the primary location (e.g., the phase one or phase two location) originates from a government-sanctioned service or organization, it is likely to be less accurate than the supplemental location (e.g., the device-based hybrid location). Therefore, the device-based hybrid location is more useful to the ESP for dispatching emergency responders to the correct, accurate emergency location.

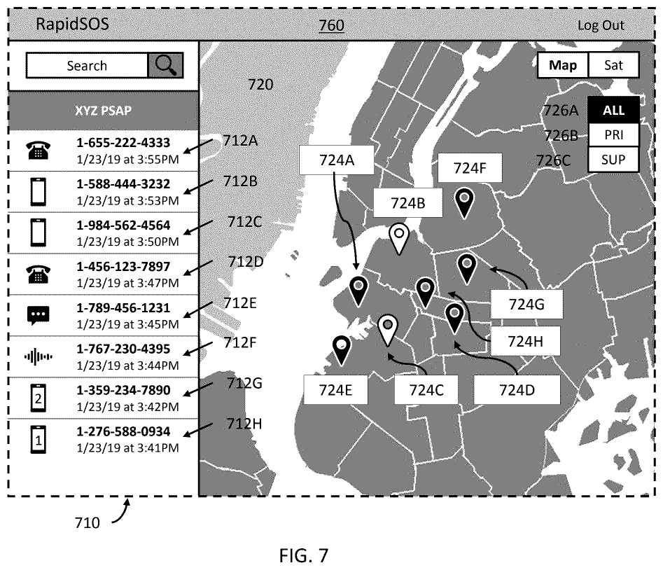

FIG. 7 illustrates an example of a graphical user interface (GUI) provided by an emergency response application with only emergency calls, in accordance with some embodiments of the present disclosure, within which both primary and supplemental emergency data are displayed (also referred to as jurisdiction view). In some embodiments, as described above, an emergency response application 760 provided to an ESP (e.g., XYZ PSAP) by an emergency management cloud server (EMCS) includes a list of incidents 710 and an interactive map 720. In some embodiments, as described above, when an emergency call is made to the ESP, the receives a user identifier (e.g., a phone number) and an emergency location associated with the emergency call. After determining the ESP as an appropriate ESP to receive emergency data regarding the emergency call (e.g., by receiving an emergency data request including the user identifier, or by processing the emergency location through a geofencing system, as described above), the cloud server then transmits and displays the user identifier as an incident 712 within the list of incidents 710 and the emergency location as an incident location 724 within the interactive map 720.

As depicted, the emergency response application 760 provides one or more options 726 for viewing incidents 712 for which primary emergency data has been received, incidents 712 for which supplemental emergency data has been received (e.g., incidents 712 for which only supplemental emergency data has been received), or both incidents 712 for which primary emergency data has been received and incidents 712 for which supplemental emergency data has been received. In the example illustrated by FIG. 7A, the option 726A for viewing both incidents 712 for which primary emergency data has been received and incidents 712 for which supplemental emergency data has been received has been selected. In response, the emergency response application 760 now displays incidents 712 and incident locations 724 for both incidents 712 for which primary emergency data has been received and incidents 712 for which supplemental emergency data has been received. For example, in this example, incidents 712A, 712D, 712E, and 712F are incidents for which only primary emergency data has been received by the cloud server and transmitted to XYZ PSAP. Incidents 712B and 712C are incidents for which only supplemental emergency data has been received by the cloud server and transmitted to XYZ PSAP. Incidents 712G and 712H are incidents for which both primary and supplemental emergency data has been received by the cloud server and transmitted to XYZ PSAP. Because the option 726A for viewing incidents generated from both primary emergency data and supplemental emergency data has been selected, the emergency response application 760 displays all of incidents 712A-712H. In this example, the emergency response application 760, which is in an all-incidents view (as described below), also displays a single incident location 724 within the interactive map 720 for each incident 712 within the list of incidents 710, respective incident locations 724A-724H. In some embodiments, all incident locations 724 displayed within the interactive map 720 when the emergency response application 760 is in an all-incidents view are displayed with a basic incident location icon, which does not indicate a type of emergency call or a type of emergency location (also referred to as a “class of service,” as described below). In some embodiments, all incident locations 724 displayed within the interactive map 720 when the emergency response application 760 is in an all-incidents view are displayed with the same basic incident location icon, such that the basic incident location icons are visually indistinct. In some embodiments, when the emergency response application 760 is in an all-incidents view, an incident location 724 associated with an incident 712 for which primary emergency data has been received by the cloud server and transmitted to the ESP accessing the emergency response application 760 is displayed with a basic incident location icon that is visually distinct from a basic incident location icon displayed for an incident location 724 associated with an incident 712 for which primary emergency data has not been received by the cloud server or transmitted to the ESP. For example, as illustrated in FIG. 7A, the basic incident location icon displayed for incident location 724A, which is associated with incident 712A, for which primary emergency data has been received by the cloud server and transmitted to XYZ PSAP, is black, while the basic incident location icon displayed for incident location 724B, which is associated with incident 712B, for which primary emergency data has not been received, is white.

In some embodiments, when primary emergency data is received by the cloud server from a primary emergency data source, the primary emergency data includes a user identifier and an emergency location (e.g., a primary location, as described above). In some embodiments, the primary emergency data also includes a type of emergency call for which the primary emergency data is associated (also referred to as a “class of service”). For example, in some embodiments, the emergency call type (or class of service) for an emergency call may be landline, mobile, voice over internet protocol (VOIP), or text. A landline emergency call type indicates a traditional emergency call made from a hardwired landline phone. A mobile emergency call type indicates an emergency call made from a mobile phone (e.g., a cell phone). A VoIP emergency call type indicates an emergency call made from internet connected device through an internet facilitated data connection. A text emergency call type indicates an emergency text (e.g., SMS, MMS, or RCS) made from a mobile phone (e.g., a cell phone). In some embodiments, the primary emergency data also includes a type of primary emergency location. For example, in some embodiments, the emergency location type for an emergency location may be a physical address, a phase one location (as described above), a phase two location (as described above), or a device-based hybrid location (as described above). In some embodiments, a class of service indicates one or both of an emergency call type and an emergency location type. In some embodiments, as illustrated in FIG. 7A, each incident 712 within the list of incidents 710 is displayed within an incident icon 714. In some embodiments, an incident icon 714 displayed for an incident 712 indicates a class of service (e.g., an emergency call type, an emergency location type, or both) associated with the incident 712. For example, the incident icon displayed with incident 712A is a landline phone icon, indicating that the emergency call type associated with incident 712A is landline; the incident icon displayed with incident 712E is a text bubble icon, indicating that the emergency call type associated with incident 712E is text; the incident icon displayed with incident 712F is a soundwave icon, indicating that the emergency call type associated with incident 712F is VoIP; the incident icon displayed with incident 712G is a mobile phone icon with a 1 on the screen, indicating that the emergency call type associated with incident 712G is mobile and that the primary emergency location type associated with incident 712G is phase one (as described above); and the incident icon displayed with incident 712H is a mobile phone icon with a 2 on the screen, indicating that the emergency call type associated with incident 712H is mobile and that the primary emergency location type associated with incident 712H is phase two (as described above). In some embodiments, the primary emergency data also includes an ESP identifier (also referred to as an “ESP ID”), which the cloud server can use to determine or identify an appropriate ESP to receive the primary emergency data (e.g., the cloud server can identify an ESP associated with the ESP identifier as an appropriate ESP to receive the primary emergency data). In some embodiments, the primary emergency data also includes an ESP user identifier (e.g., a a call-taker position ID), as described below.

### Emergency Messaging

Traditionally, a user reporting an emergency has to place an emergency call, which will be routed to the local ESP agency serving the area. In some places, a user may have the option to text-to-911 in areas where the local ESP agency has the capabilities to receive and respond to text-to-911 messages. However, in many areas, the local ESP agency does not have capability to receive text-to-911 messages and users in an emergency may receive a bounce back message if they try to contact 911 using text messaging and their only option is to make an emergency call.

In many situations, it may be difficult for the user in the emergency to call 911 for various reasons. First, there could be an outage in the ESP agency or the phone network, which prevents the user from making an emergency call. Second, the user may be in a situation where it is not easy to make an emergency call such as a domestic violence situation or a loud factory floor and messaging may be the preferred alternative. Third, for some users with a disability or due to personal preference, it may be better to reach out for emergency help via emergency messaging. In addition, an emergency call may drop or may have low audio quality due to bad signal or disturbances, which may make it difficult or time consuming to communicate the information about the emergency to the ESP personnel in an efficient and accurate way. In many situations, even if the user is able to connect to the ESP agency by redialing, he or she may be connected to a new ESP user and may have to start at the beginning to explain the emergency. For these reasons, the systems, methods and applications described herein provide ways to get emergency help from ESP agencies who are not currently capable.

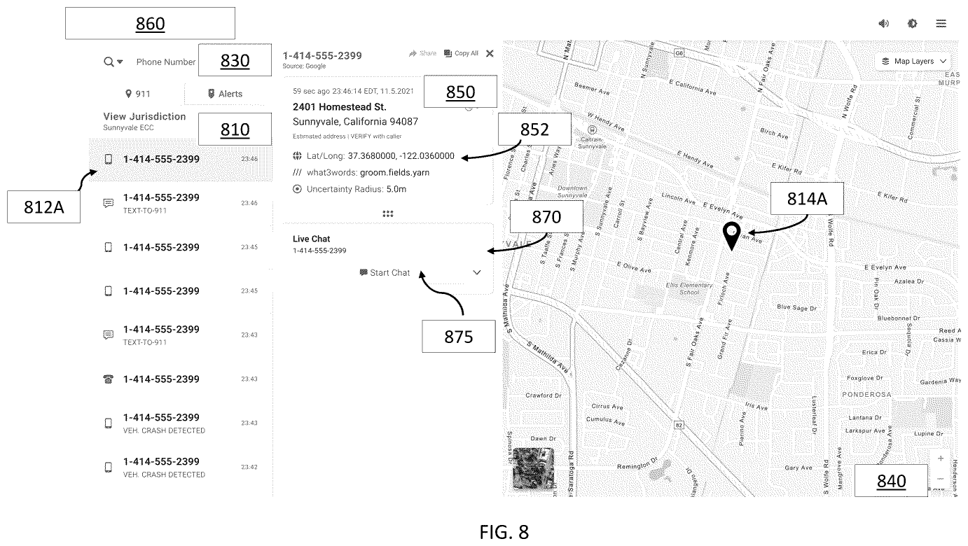

FIG. 8 illustrates an example of a GUI provided by an emergency response application for initiating a real time messaging session, in accordance with some embodiments. As shown, the GUI 860 includes a queue of emergency communications 810, emergency data card 850, search bar 830, and an interactive map 840. When a wireless emergency call 812A is selected by an ESP user (see mobile icon indicating the method of communication), the location (i.e., location coordinates 852) of the emergency call is plotted at location marker 814A on the interactive map 840. In some embodiments, the user in an emergency may have called 911 and been disconnected or hung up. In some cases, the ESP user may suspect that the user may be in an emergency due to a dropped call, attempted call or text or is within an affected area.

In such cases, the ESP user may open the communicator app 870 and be prompted to start emergency communication session with the user to determine the nature of the emergency and send appropriate emergency response. For example, the ESP user may press the real time chat button 872 to initiate two-way communication session. The ESP user can control and manage the communication by use of automated bot, use of pre-formatted messages or canned messages as described below.

### Pre-Formatted Messages

In some embodiments, the ESP agency may have a collection of pre-formatted messages that can be sent in various scenarios. The advantages of preformatted messages are to save time of the ESP user, follow standard operating procedures (SOPs) and maintain some standardization in the emergency messages. In the case of 911, pre-formatted messages with standard language in line with user expectations will increase trust and reduce confusion. In some embodiments, the user in an emergency is also offered a list of options of pre-formatted responses or IVR responses. In this way, the efficiency and effectiveness of emergency communication can be maintained.

For example, the initial message from the ESP user may be pre-formatted in a standard format so as to establish trust that the message is from a 911 agency and not from dubious source. The content of the pre-formatted message may depend on the standard practice in the local ESP. For example, the pre-formatted message may identify the local ESP agency by name, e.g., “This is 911 operator for the City of Chicago” or “This is Chicago 911 agency. What is the nature of your emergency?” The user may also be guided to choose a from a list of pre-formatted responses such as “Press 1 for Fire, 2 for Police, 3 for Medical, . . . ”, etc. In this way, the emergency messaging session can be standardized, clear and require minimal effort.

In some implementations, an automated bot may be used to initiate the emergency messaging session and go through some preliminary queries. After the threshold inquire of the nature and location of the emergency, the ESP user may be connected to takeover the session. In this way, the efficiency of the sessions can be improved and can alleviate the staffing crisis at many ESP agencies.

### AI Engine & Prompt Engineering

In some embodiments, the EMCS may include an AI engine for processing emergency calls & messages, non-emergency calls & messages, and alarms & alerts. The AI engine may include a large language model (LLM) or some other machine learning (ML) logic, according to an embodiment. An example of an AI engine is a Generated Pre-trained Transformer (GPT). A GPT is a type of LLM that may be able to generate human-quality text, write various kinds of content, and answer questions in an informative way. The AI engine may be configured to create new text, rather than simply processing or analyzing existing text. The AI engine may be pre-trained on significant sizes or quantities of datasets of text and code, which provides a foundation of knowledge to build upon. The AI engine may include a neural network architecture such as a transformer, which is configured to handle long sequences of data (e.g., sentences and paragraphs). Although the AI engine may be implemented as a GPT, other LLMs and machine learning implementations may be used.

The automated bot may be designed to conduct routine and standardized tasks to reduce burden on ESP call taker. Thus, the automated bot may confirm the nature and location of the emergency. The AI engine running the automated bot is capable of processing and guiding the intake process before the real time messaging session with ESP user. The emergency data obtained by the AI engine may include but is not limited to, an address of the emergency, the nature of the emergency (e.g., fire, flooding, etc.), a residential or business name, a premises phone number, a first and last contact name, a zone or area of the source of the alarm within the premises, the number of attempts made to verify the alarm, a verification, a summary, or the like.

### Monitoring Center Solutions & Emergency Alarms

As referred to herein, a monitoring center or central station is an organization that provides monitoring and call-taking services for security systems. A monitoring center staffs one or more call-takers (typically on a 24/7 basis) who monitor the status of one or more security systems, and, when an alarm (e.g., an emergency alert autonomously generated by a device or system) is generated by one of the one or more security systems, one of the one or more call-takers responds to the alarm according to a predetermined response protocol (e.g., by calling one or more persons associated with the security system, such as a homeowner or a security guard, or by contacting emergency services). The monitoring and call-taking services provided by monitoring centers for security systems perform an essential role in emergency response by determining if an alarm represents a real emergency (and, if so, informing the appropriate authorities), or if an alarm does not represent a real emergency (e.g., a false positive). In some embodiments, a monitoring center system is associated with one or more monitoring centers (e.g., physical locations that house hardware, software, or human components of the monitoring center system). In some embodiments, a monitoring center system is not associated with any particular physical location but is instead composed of a distributed network of hardware, software, and human components. As used herein, a “monitoring center system” includes all of the hardware components (e.g., one or more computing devices, one or more server systems, etc.), software components (e.g., alarm handling software applications, call handling software applications, etc.), and human components (e.g., one or more call-takers) of a monitoring center. As used herein, a “private security system” (PSS) is an entity that provides alert-generating products and services for sale to the general public and includes all of the hardware components (e.g., devices and sensors, server systems, etc.) and software components (e.g., web applications, mobile applications, etc.) necessary to provide those alert-generating products and services. For example, in some embodiments, a private security system is a “do it yourself” (DIY) home security company that provides off-the-shelf devices (e.g., security cameras, smoke detectors, etc.) that a consumer can purchase and install in their home. The consumer may be able to configure or otherwise control those off-the-shelf devices by using a mobile application provided by the DIY home security company and installed on the consumer's mobile device (e.g., the consumer's cell phone). Or, for example, in some embodiments, a private security system 1376 is a personal emergency response system (PERS) company that provides a smartwatch that can detect when a wearer is experiencing low blood oxygen levels.

In some embodiments, a user at the monitoring center verifies the alarm and sends the verified alarm as an emergency alert to an ESP. In some cases, the user at the monitoring center may call emergency or non-emergency line at the ESP. Emergency messaging provides an alternate method for the user at the monitoring center to contact the ESP, which may lead to faster response. In some embodiments, the real time messaging session further comprises an operator at a monitoring center who has initiated an emergency alert on behalf of the user. In some embodiments, the real time messaging session further comprises initiating a three-way real time chat between the user, the operator at the monitoring center and the ESP.

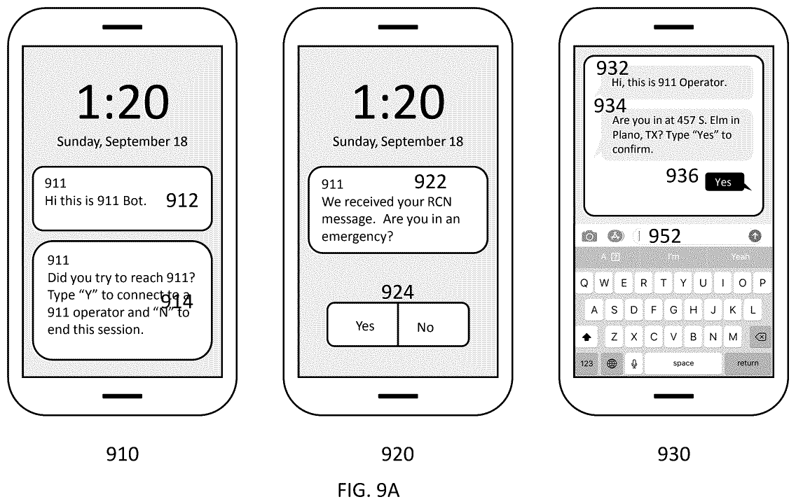

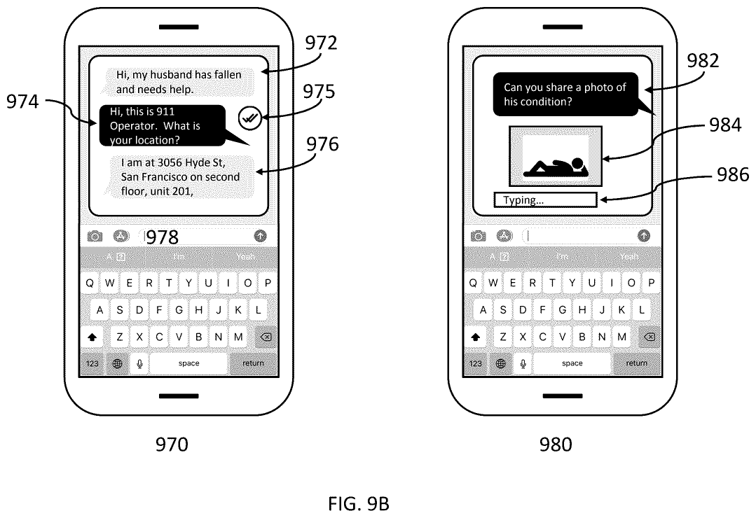

FIGS. 9A & 9B illustrate examples of GUI of a real time messaging session on a mobile device of the user in an emergency or an emergency responder, in accordance with some embodiments As shown in GUI 910 on the user device, an automated bot may identify users who may be in an emergency. For example, an automated bot may also initiate the emergency communication session via emergency messages 912 & 914.

In some embodiments, the ESP user may initiate the emergency communication as depicted in FIG. 8, where the ESP user may have seen that a person is trying to reach 911 or has been disconnected. As shown in GUI 920, a text message from the ESP user may be received at the user device wherein a user in an emergency can confirm if they are in an emergency. In some cases, the user in the emergency may be unable or find it difficult to make an emergency call and explain their situation. Thus, initiation of the emergency communication session by the ESP user may be preferred. In addition, this method of communication allows the user to respond to a message from their local ESP agency instead of trying to get routed to the appropriate ESP by calling 911. In a subsequent screen (not shown), the user in the emergency may be prompted to confirm their location obtained from the ALI or a device-based hybrid location generated on the use device.

In another GUI 930, the emergency communication session 950 is depicted where the user is being prompted to confirm their street address after they have sent an emergency message requesting emergency assistance. As depicted in the two-way message exchange, the user responds to messages 932 and 934 from the local ESP agency by responding 936 via interface 952. The user can also share multimedia files with the ESP user to provide information about the emergency. In addition, the user may be able to translate the messages into another language via one-way translation process.

### Transcription/Translation/IVR/Voice-to-Text,/Text-to-Voice

As disclosed herein, the use of transcription, translation, voice-to-text, text-to-voice, etc., and IVR are powerful tools that can allow efficient management of emergency responses. In some embodiments, the voice call is first transcribed and then processed and translated while in others the voice call is translated and processed in raw audio form or minimal processing.

As an initial step, language determination system (LDS) can be configured to receive the emergency communication from emergency data source 500. In some examples, the emergency communication can include at least one of a short message service (SMS) message, rich communications (RCS), an internet-based messaging, all or portions of an emergency call, a recorded audio/video feed, a real time audio/video feed, or the like. In some examples, the emergency call can include a landline call, a cellular line call, a Voice over Internet Protocol (VoIP) call, or the like. According to some embodiments, LDS can be configured to determine (or predict) the language of the emergency communication that language determination system receives from emergency data source. Additionally, or alternatively, language determination system 511 can be configured to determine (or predict) that the language of the emergency communication is different from a standard language.

According to some embodiments, LDS can compare the received emergency communication and its associated determined (or predicted) language with emergency communications and their associated determined (or predicted) languages in database (e.g., 100+languages) to determine the probability value indicating the confidence level that the determined (or predicted) language is an accurate language of the emergency communication. Additionally, or alternatively, LDS can provide (e.g., display) the received emergency communication and its associated determined (or predicted) language to an ESP admin, or specialized personnel, to validate that the determined (or predicted) language is accurate. In some embodiments, language determination system 511 can use a portion of (or all of) the emergency communication, the determined (or predicted) language, and the determined probability to train or update an algorithm of machine learning model to assist LDS to determine (or predict) a language of the emergency communication (or to determine that the language of the emergency communication is different from the standard language) with higher probabilities. Additionally, LDS can display the determined probability indicating the confidence level associated with the determined language for the ESP user.

After determining (or predicting) the language of the emergency communication (and/or determining that the language of the emergency communication is different from the standard language), translation system can translate the emergency communication from the determined language to the standard language, according to some embodiments. In some embodiments, translation system can use the converted text data from LDS and/or database. The translation system can translate the converted text data from the determined language to the standard language and can generate a translated text data. The second text data is in the standard language. In a non-limiting example, the translation system can use a Google Translation API and/or Google Cloud Translation API for translating the emergency communication. However, the embodiments of this disclosure are not limited to this example and translation system can use other methods and systems to translate the emergency communication. In some embodiments, the raw audio file is made available for the ESP user to listen to side by side with the translation, so that the ESP user can listen to the audio for additional details.

In FIG. 9B, the GUI 970 depicts an emergency message 972 from a user indicating a need for emergency help for her husband. In some embodiments, the emergency message 972 entered via user interface 978 may be a text-to-911 message, an SMS, an MMS, RCS message. In some embodiments, the emergency communication session includes enhanced messaging such as RCS, which allows users to share high-quality multimedia files, participate in group texts, see read receipts and typing status. For example, the two-way emergency communication session may include messages 974, 976 and may show read receipt indication 975. Thus, the ESP user is able to see that the user in the emergency is active and has seen the message 974.

In GUI 980, the ESP user is able to use the emergency messaging session to gain information about the patient's condition by asking for a photo 982. It is important for the user to be able to share multimedia files such a photo or video feed of the patient as shown in 984. In this way, the ESP user can provide information about the patient's condition with first responders and direct the user on what to do while waiting for responders (e.g., how to stop the bleeding). Here, enhanced messaging (e.g., RCS) is depicted where the user can see that when the ESP user is actively typing 986.

### Audio-Visual Notifications

Various methods for audio-visual notifications may be used, in accordance with the various embodiments, for gaining the notice of the ESP user when emergency messages are received at the ESP (e.g., text-to-911 messages, RCN messages, etc.). However, it is important to ensure that the notifications are not overwhelming and they can be turned off. For example, after the user has sent a text-to-911 message to the ESP, the visual indication of the emergency communication is indicated with a blinking visualization or sound notification to alert the ESP user, wherein the blinking visualization or sound notification can be turned off.

### Emergency Messaging Session Termination

After an emergency message session is initiated, it is critical that the session is terminated in a definite and reliable fashion. In daily life, messaging sessions between people can continue indefinitely and the user can initiate a message at any time. In addition to initiation of the session, it is also important for the local ESP agency and ESP users to have control over the termination of the emergency messaging session. Due to the critical and time-sensitive nature of emergencies, there should be a definite and clear termination to the emergency messaging session so that the ESP user can move on to other emergency calls without having to monitor multiple open emergency messaging sessions. Also, each emergency incident may be recorded and archived after termination.

For these reasons, it is important that the user has limited ability to initiate and terminate sessions and automated protocols can be implemented to address situations when a user is trying to reinitiate the session. In this way, the user expectations can be managed effectively and efficiently. In some embodiments, the entry in the queue is removed after termination or after a short period of time after termination.

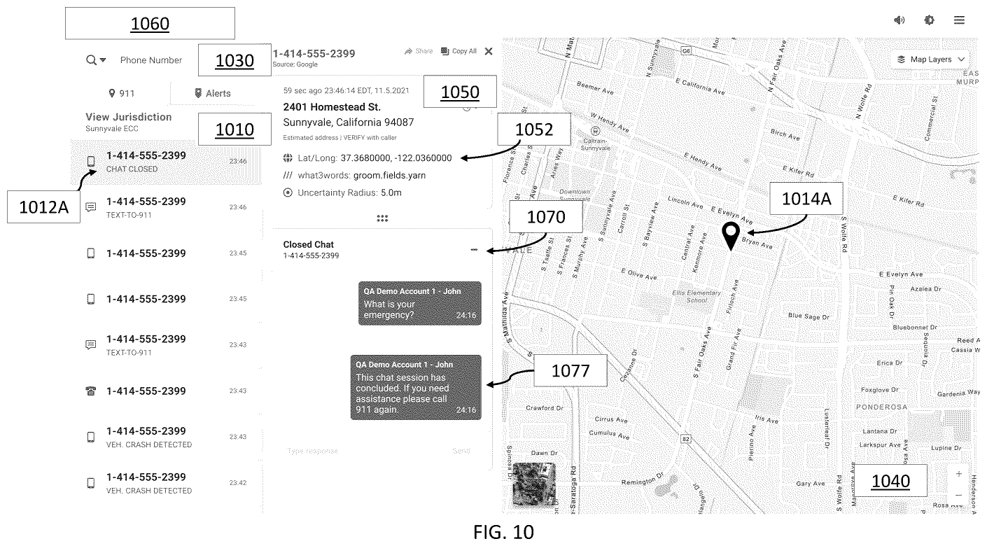

FIG. 10 illustrates an example of a GUI provided by an emergency response application after terminating a real time messaging session, in accordance with some embodiments. As shown, the GUI 1060 includes a queue of emergency communications 1010, emergency data card 1050, search bar 1030, and an interactive map 1040. When a wireless emergency call 1012A is selected by an ESP user (see mobile icon indicating the method of communication), the location (i.e., location coordinates 1052) of the emergency call is plotted at location marker 1014A on the interactive map 1040. In some embodiments, the user in an emergency may have called 911 and been disconnected or hung up.

As depicted, the communicator app 1070 can be used to terminate the emergency communication session or 2-way exchange between the user in an emergency and an ESP user. For example, the ESP user may have initiated the emergency communication session, but without a response from the user within a specific timeout period, an automated termination protocol is initiated. In some embodiments, the timeout period may vary between 1 to 10 minutes. As depicted, an automated termination message 1077 may be sent to the user device. Although not shown, a bounce back protocol may be initiated if the user tries to re-initiate the emergency session, e.g., a bounce back message informing the user that the session has been terminated and the user should call 911.

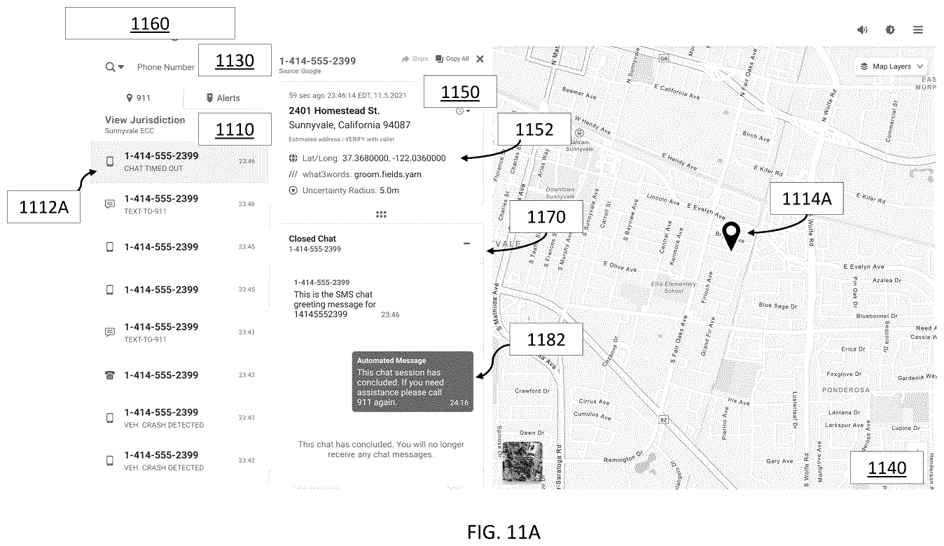

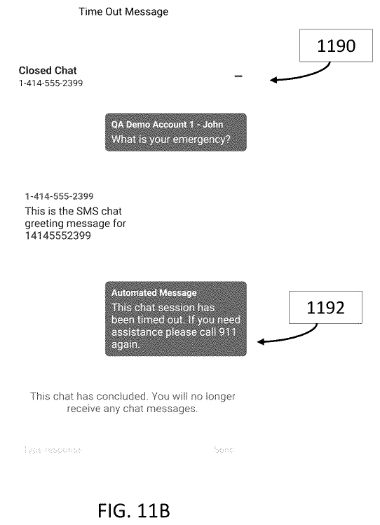

FIGS. 11A & 11B illustrate examples of a GUI of termination protocol on an emergency response application accessible at an ESP agency and a mobile device of the user in an emergency. As shown, the GUI 1160 in FIG. 11A includes a queue of emergency communications 1110, emergency data card 1150, search bar 1130, and an interactive map 1140. When a wireless emergency call 1112A is selected by an ESP, the location (i.e., location coordinates 1152) of the emergency call is plotted at location marker 1114A on the interactive map 1140.

As depicted, the communicator app 1170 can be used to terminate the emergency communication session or 2-way exchange between the user in an emergency and an ESP user. For example, the ESP user may have initiated the emergency communication session, but without a response from the user within a specific timeout period, an automated termination protocol is initiated. In some embodiments, the timeout period may vary between 1 to 10 minutes. As depicted, an automated termination message 1182 may be sent to the user device. Although not shown, a bounce back protocol may be initiated if the user tries to re-initiate the emergency session, e.g., a bounce back message informing the user that the session has been terminated and to call 911 instead.

As depicted in FIG. 11B, the user device messaging GUI 1190 depicts that the user may receive an automated termination message after a timeout of the emergency messaging session. In some embodiments, the timeout period can be set to a default time between 1-10 minutes. In some embodiments, the timeout period can be changed based on ESP agency preferences, best practices, regulations, etc. In some embodiments, the ESP user may be given the option to wait longer after the timeout period has expired before the session termination. For example, the user may not have responded in the timeout period of 2 minutes, but the telecommunicator may override the timeout if she would like to give more time for the user to respond. Thus, it is advantageous to give the ESP user control over session termination.

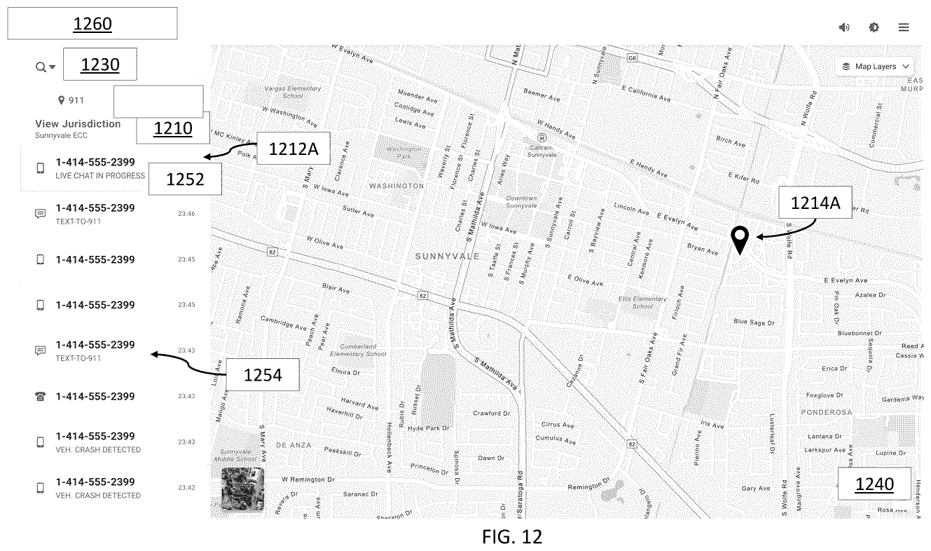

FIG. 12 illustrates an example of a GUI provided by an emergency response application indicating session status. As depicted, GUI 1260 includes a queue of emergency communications 1210, and an interactive map 1240. When a wireless emergency call 1212A is selected by an ESP user, the location of the emergency messaging session is plotted at location marker 1214A on the interactive map 1240. The session indicator 1252 indicates that “Live Chat in Progress” for that emergency communications. For example, another ESP user (e.g., call taker) may be in an emergency messaging session with the user and it can indicate to the viewer that they can address another emergency communication in the queue 1210. In some embodiments, the session status includes real time chat in progress, location shared, video shared, timeout, terminated, repeat caller, etc.

An advantage of the systems, methods, GUIs disclosed herein is that the two-way messaging platform can allow a user in an emergency with the local ESP agency which is responsible for emergency response (i.e., the appropriate ESP) where the local ESP agency may not be capable of receiving text-to-911 messages. It is understood that the ESP agency may also be able to receive the emergency message even if they are capable of receiving text-to-911 messages, as depicted in FIG. 12 (emergency communication 1254 is indicated to be a text-to-911 communication session). In this way, the emergency messaging disclosed herein can provide a communication method in areas that currently do not have such options with local ESP agencies with various needs and capabilities. Also, emergency messaging can be advantageous for many users with disabilities, language preferences and difficult situations.

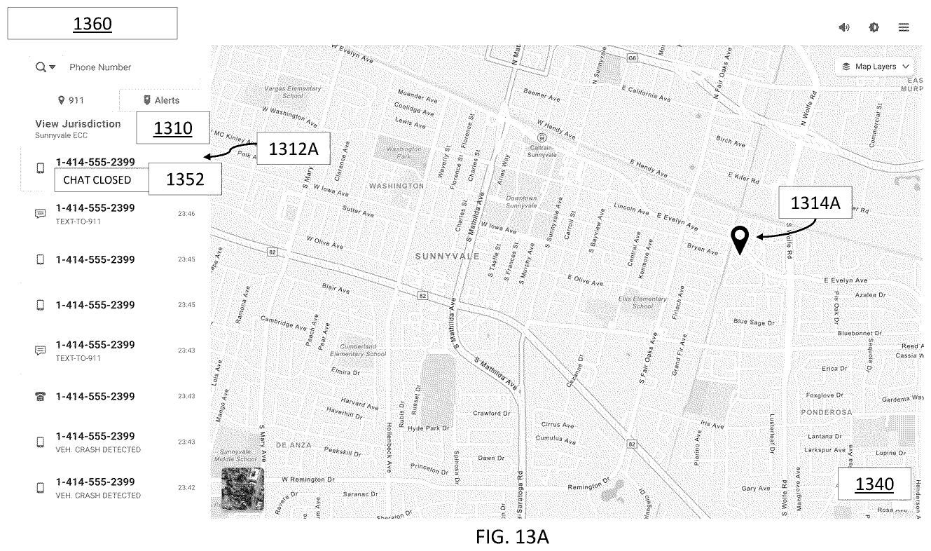

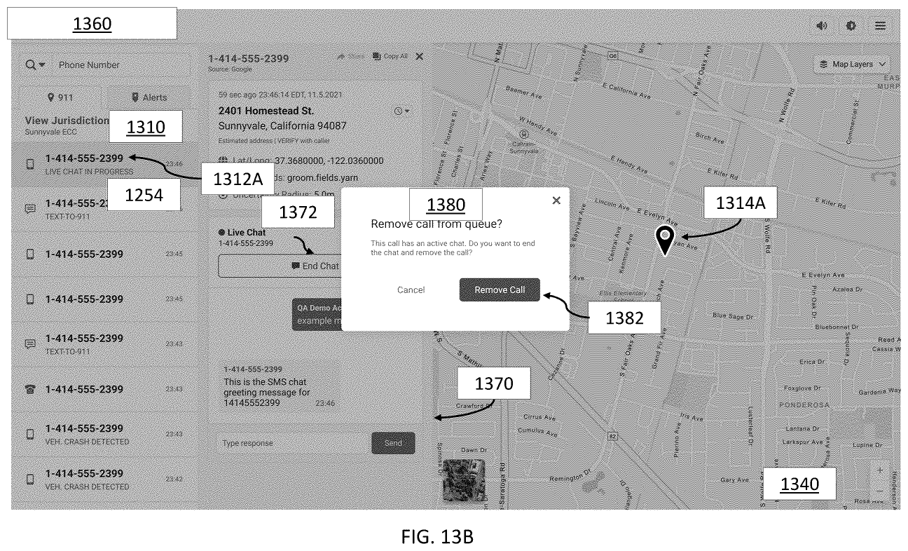

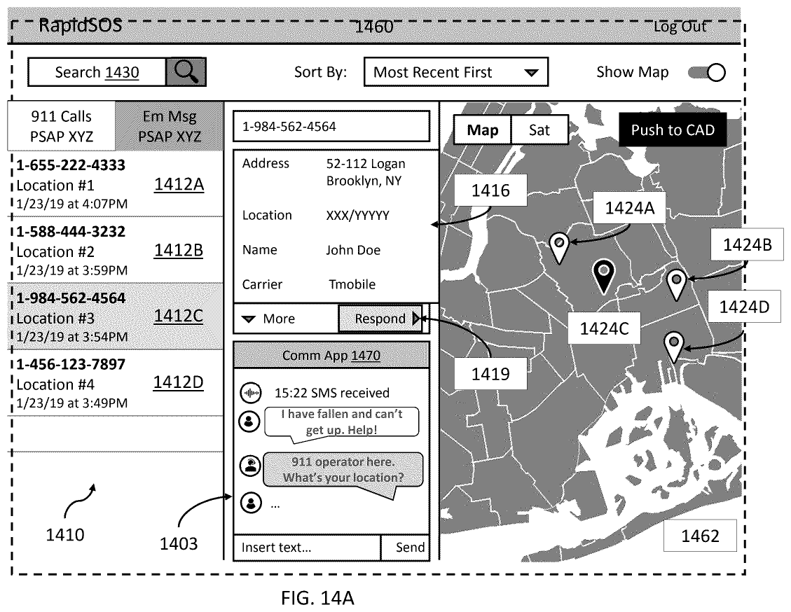

FIGS. 13A & 13B illustrate examples of GUI of termination of an emergency messaging session at an emergency response application accessible at an emergency service provider (ESP). As depicted, GUI 1360 includes a queue of emergency communications 1310, and an interactive map 1340. When a wireless emergency call 1312A is selected by an ESP user, the location of the emergency messaging session is plotted at location marker 1314A on the interactive map 1340. The session indicator 1352 indicates that “Chat Closed” for the emergency communication 1312A.

In FIG. 13B, GUI 1360 includes a queue of emergency communications 1310, and an interactive map 1340. When a wireless emergency call 1312A is selected by an ESP user, the location of the emergency messaging session is plotted at location marker 1314A on the interactive map 1340. Here, the ESP user has started an emergency session with the user associated with emergency communication 1312A via Communicator App 1370. The session indicator 1354 indicates that “Live Chat in Progress” for the emergency communication 1312A.

As depicted, the ESP user may have ended the emergency messaging session in the Communicator App 1370 by pressing the “End Chat” button 1372. An option to remove the entry 1312A in the queue 1310 is presented to the ESP user via pop-up window 1380. Although not shown, pressing the button 1382, the emergency communication that has been resolved can be removed from the queue.

### Queue Management

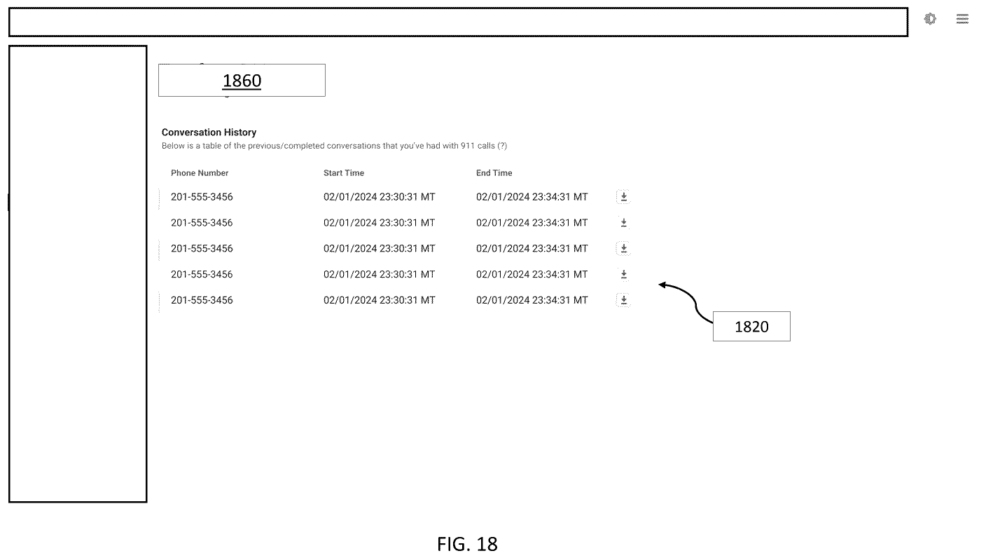

Traditionally, the call queue at ESP agencies were populated as emergency calls were routed to the agency. Thus, call takers at ESP agency did not have sufficient control over their queue and sequentially answered calls. An advantage of the systems, methods, GUIs disclosed herein allows the ESP user to have greater control over the management of the call queue (also referred to as alerts queue or emergency communication queue). By being able to remove entries associated with closed emergency sessions, the ESP user can move on to responding to other emergencies. Even if the entry has been deleted from the queue, the emergency messaging sessions are available in the archives shown in FIG. 18.

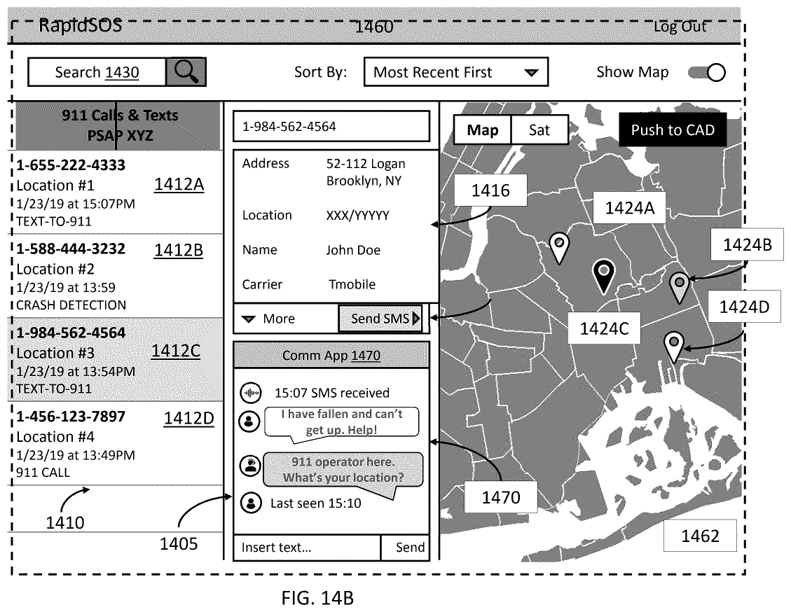

FIGS. 14A & 14B illustrate examples of GUI of a real time messaging session at an emergency response application accessible at an emergency service provider (ESP). As depicted, GUI 1460 includes a queue of emergency calls and emergency messaging 1410, a search bar 1430, an emergency data card 1416, a communicator app 1470 and an interactive map 1462. As depicted, the queue 1410 includes a tab for emergency calls and another tab for emergency messaging (selected) including entries 1412A-C. In addition, the GUI 1460 is a jurisdictional view for the ESP agency (here PSAP XYZ) where other location markers for the emergency messages in the queue 1410 are shown in the interactive map 1462. The jurisdiction can provide situational awareness about other emergencies happening nearby and helps information for management of emergency resources. When an emergency message 1412C is selected by an ESP user, the location of the emergency messaging session is highlighted at location marker 1424C on the interactive map 1462 with a change in visual appearance from the other location markers in the jurisdiction view (here the color of the selected location is visually different).

In FIG. 14A, the user in an emergency can initiate the two-way communication session by sending a text-to-911 or an enhanced emergency message (e.g., RCS). The ESP user can respond by pressing the respond button 1419. The communicator app 1470 allows for the ESP user to interact with the user in the emergency. Specifically, the ESP user can see when the user is typing (see typing indication 1403), so that he or she knows that the user is actively communicating.

In FIG. 14B, the user in an emergency can initiate the two-way communication session by sending a text-to-911 or an enhanced emergency message (e.g., RCS). Here the user has last seen the message at 15:10 (see session status 1405) and the ESP user may terminate the session, reach the user by calling the user at that number or an alternate number, calling emergency contacts, etc.

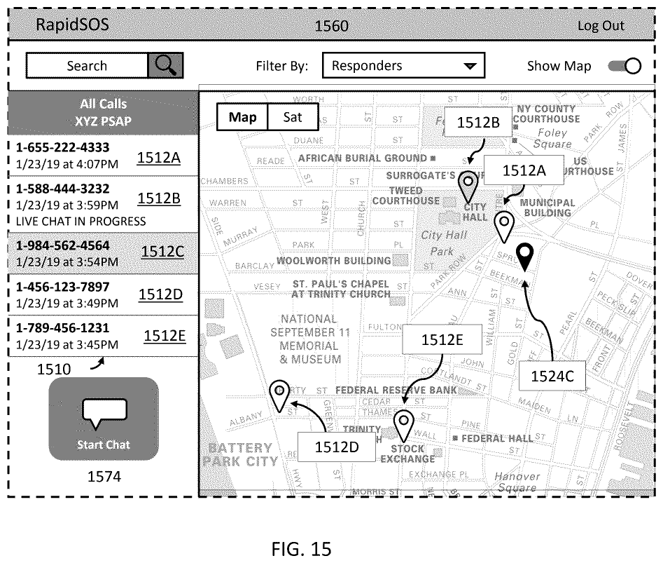

FIG. 15 illustrates an embodiment of a GUI provided by an emergency response application for an ESP user to start a communication channel with a user device. As depicted, GUI 1560 provided by an emergency response application for an ESP user (e.g., a telecommunicator) to start a communication channel with a user device (e.g., a caller reporting a medical emergency). In some embodiments, the GUI includes a call queue 1510 with a list of emergency calls, messages and/or alerts and an interactive map 1520. As depicted, the location of each emergency call 1612A-E is indicated by location markers 1524A-E on the interactive map 1520. Here, the ESP user can see that emergency call 1512A is sharing real time feed with another user in the system and the location markers has a visual different from other location markers. In this case, the ESP user selects the next emergency call 1612C in the queue 1610 and is presented with a “start chat” button 1574 to initiate a two-way communication session with the emergency caller. In some embodiments, an ESP user may initiate an emergency message to the phone number by text, data SMS, HTTP, or other types of messages.

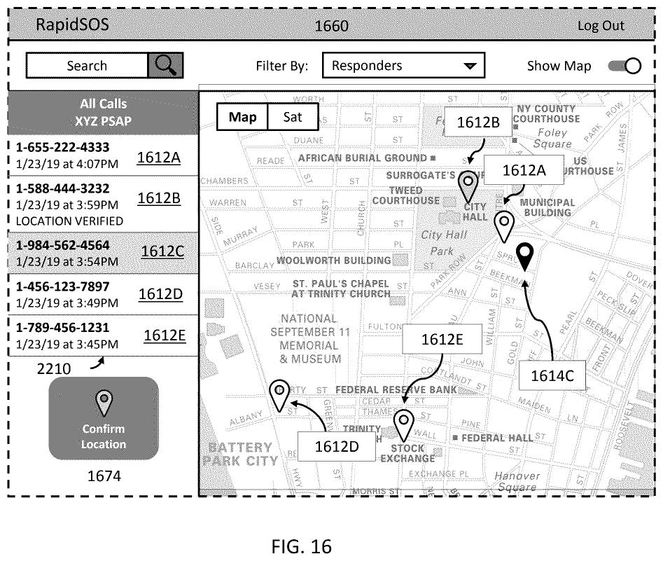

FIG. 16 illustrates an embodiment of a GUI provided by an emergency response application for an ESP user to confirm the location of the user device. As location is a critical piece of emergency data, the ESP user may confirm the location of the emergency caller by various ways. For example, GUI 1660 provided by an emergency response application for an ESP user to confirm the location of the user device. As depicted, the location of each emergency call 1612A-E in the call queue 1610 is indicated by location markers 1624A-E on the interactive map 1620. Selection of the confirm location button 1674 will initiate a request for a device-based hybrid location of the user device. Once the location data is received from the user device, the location marker 1624 on the interaction map 1620 may be adjusted accordingly.

In some embodiments, the location of the user device may be in the vicinity of the location of the multimedia device such as a camera. The user device may connect to the camera via a first communication link, such as Wi-fi hotspot. Thus, the location of the user device would be within the range of Wi-fi, typically within 150 feet in indoor locations and within 300 feet in outdoor locations.

### Sharing Multimedia

Previously, a caller on an emergency call was only able to share audio information to a telecommunicator, which had to be entered and passed on to dispatchers and responders who provide emergency response on the ground. It is desirable for obtaining multimedia feed from the emergency with rich situational awareness information for effective and efficient emergency response.

It is said that a picture is worth a thousand words and this can be even more true for a video feed. The situational awareness information that can be gleaned from multimedia feed may vary. In some cases, the visual of the emergency can allow public safety personnel, with or without the help of artificial intelligence, identify a person with a weapon a broken window, a car on fire, etc., which can help in identifying the type and priority (e.g., critical, non-critical, non-emergency) of the emergency. For example, it is important to for emergency responders visual attributes of a patient in a medical emergency. In addition, the situation around the emergency may be important for planning the response, such as advising the caller on what to do while waiting for help, what is a feasible approach to a building on fire, etc. Such systems and methods for sharing the multimedia feed from the emergency to multiple stakeholders in the public safety pipeline (callers, primary, secondary or responders) will be particularly advantageous.

While video calling technology is widely available, this technology has not been adopted in public safety for various reasons. There are some challenges for providing access to the multimedia feed starting with providing the feed to the right stakeholders at the relevant time. In addition, getting consent of the person who is generating the multimedia feed may be important. The technology for accessing and transmitting large files associated with multimedia feeds can be challenging. As described below, the systems, methods disclosed herein allow sharing of multimedia files during the emergency messaging session for effectively and efficiently situational awareness directly from the user in the emergency with public safety personnel (e.g., call takers, dispatchers, first responders).

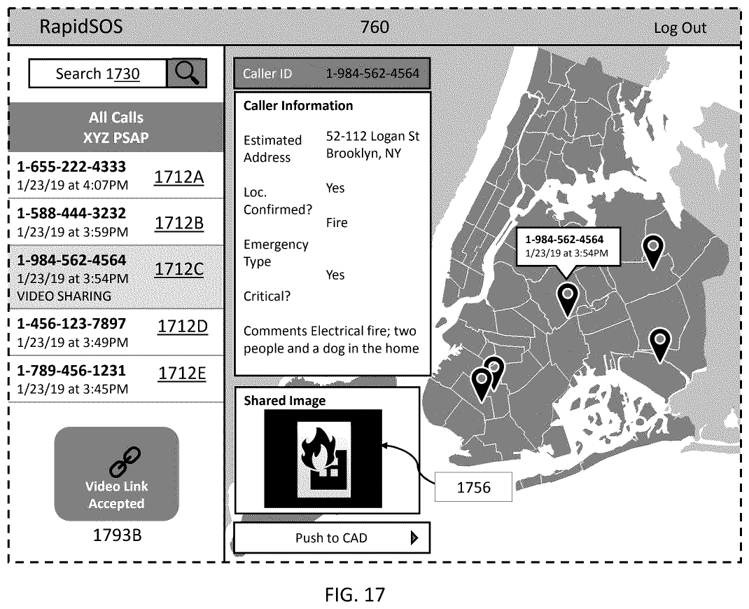

FIG. 17 illustrates an embodiment of a GUI provided by an emergency response application for sending a multimedia request to a user device. As shown, GUI 1760 provided by an emergency response application for sending a multimedia request to a user device. In some embodiments, the GUI includes a call queue 1710 with a list of emergency calls, a search function 1730, and an interactive map 1720. As depicted, the location of each emergency call 1712A-E in the call queue 1710 is indicated by location markers 1724A-E on the interactive map 1720. Selection of the emergency call 1712C causes the corresponding location marker 1724C visually indicating the selection with a blurb and opening an emergency data card 1750 with the emergency data related to the emergency call. For example, the emergency caller reported elderly man collapsed who is likely cardiac arrest and the front door is locked. Although not shown, the telecommunicator may enter notes about the emergency call that can become part of the emergency data associated with the emergency call and then forwarded to CAD. Here, an option is displayed for sharing the emergency data associated with the emergency call including a multimedia feed to an emergency responder via 1778. In this way, the medical condition of the elderly man can be viewed and monitored by responders to prepare for effective and efficient response.

Here, the selection of multimedia request button 1774 by a telecommunicator initiates a request to be sent to the user device. Once an image file or video feed is received, it may be stored in a multimedia server (not shown) within the emergency management cloud server (EMCS) the multimedia file may be displayed in the media screen, now showing that the elderly man is on the floor. In some situations, there could be disturbing scenes shown in the video and the ESP user may be given control options for the multimedia feed such as no sound 1784, blur (not shown), end feed (not shown), etc. In this way, the multimedia feed can be removed by the ESP user for disturbing or inappropriate content.

FIG. 18 illustrates an embodiment of a GUI provided by an emergency response application for accessing recordings and archives of emergency calls and emergency messages. As shown, GUI 1860 comprises a message history and includes a list 1820 of historical emergency messaging sessions. Through this page, an ESP user can access prior emergency messaging sessions and also download them.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

1. An emergency management cloud server operative to be communicatively coupled to a user device and to a plurality of emergency service provider (ESP) terminals at a plurality of ESPs, the emergency management cloud server configured to:
identify a user in an emergency, the user associated with the user device;
obtain a location of the emergency, the location generated by the user device;
determine an ESP, from the plurality of ESPs, that can provide an emergency response to the location based on the location being within a service area of the ESP;
provide a prompt at an ESP terminal of the ESP to initiate communication with the user device via the emergency management cloud server;
receive an input from the ESP terminal in response to the prompt; and
initiate a real time messaging session between the user device and the ESP terminal in response to the input.

2. The emergency management cloud server of claim 1, further configured to:
initiate the real time messaging session in response to receiving a confirmation from the user device.

3. The emergency management cloud server of claim 1, further configured to:
receive a location confirmation from the user device; and
initiate the real time messaging session in response to receiving the location confirmation.

4. The emergency management cloud server of claim 1, further configured to:
provide an emergency response application instance to the ESP terminal via a web browser executed by the ESP terminal;
receive a control input from the emergency response application instance; and
initiate the real time messaging session in response to receiving the control input.

5. The emergency management cloud server of claim 4, further configured to:
receive a phone number for the user device from the ESP terminal; and
initiate a real time messaging session in response to receiving the phone number.

6. The emergency management cloud server of claim 1, further configured to:
initiate the real time messaging session using a preformatted message.

7. The emergency management cloud server of claim 1, further configured to:
provide the user device with selectable pre-formatted responses to an initial message sent to the user device.

8. The emergency management cloud server of claim 1, further configured to:
provide to the ESP terminal an activity level from the user device after the ESP terminal has sent a message to the user device, the activity level selected from a list consisting of: last seen, sent, read receipt, and typing.

9. The emergency management cloud server of claim 1, further configured to:
re-initiate the real time messaging session between the ESP terminal and the user device.

10. The emergency management cloud server of claim 1, further configured to:
prevent the user device from re-initiation of the real time messaging session after termination.

11. The emergency management cloud server of claim 1, further configured to:
enable the ESP terminal to terminate the real time messaging session; and initiate a close of session protocol in response to termination.

12. The emergency management cloud server of claim 1, further configured to:
terminate the real time messaging session in response to expiration of a timeout.

13. The emergency management cloud server of claim 12, further configured to:
terminate the real time messaging session in response to a timeout configurable to be between one to ten minutes duration.

14. The emergency management cloud server of claim 13, further configured to:
extend duration of the timeout in response to input received from the ESP terminal.

15. The emergency management cloud server of claim 1, further configured to:
provide an indication to the ESP terminal when a text-to-911 message is sent from a user device to an ESP corresponding to the ESP terminal, the indication configurable by the ESP terminal via an on-off toggle.

16. The emergency management cloud server of claim 1, further configured to:
provide a status of the real time messaging session to the ESP terminal in an emergency queue, the status consisting of options: active and closed.

17. The emergency management cloud server of claim 16, further configured to:
provide the status in the emergency queue in response to initiation of the real time messaging session.

18. The emergency management cloud server of claim 16, further configured to:
remove an entry in the emergency queue corresponding to the real time messaging session in response to termination of the real time messaging session.

19. The emergency management cloud server of claim 16, further configured to:
receive an input from the ESP terminal; and
remove an entry in the emergency queue corresponding to the real time messaging session in response to the input.

20. The emergency management cloud server of claim 1, further configured to:
display the real time messaging session to appear as a message type selected from message types consisting of: a short-message-service (SMS) message exchange, a multi-media message service (MMS) message exchange, and a rich communication services (RCS) message exchange, when the ESP corresponding to the ESP terminal does not have text-to-911 capability.

21. The emergency management cloud server of claim 1, further configured to:
establish the real time messaging session between the ESP terminal and the user device wherein the user device is enabled to utilize rich communication services (RCS).

22. The emergency management cloud server of claim 1, further configured to:
determine a language of a real time message received by the ESP terminal and sent by the user device;
translate the real time message received by the ESP terminal into a preferred language; and
translate further real time messages sent from the ESP terminal from the preferred language to the language determined for the real time messages received by the ESP terminal.

23. The emergency management cloud server of claim 1, further configured to:
translate messages of a real time messaging session sent from the ESP terminal to the user device.

24. The emergency management cloud server of claim 1, further configured to:
translate messages of a real time messaging session in response to an emergency.

25. The emergency management cloud server of claim 1, further configured to:
send recorded voice messages during the real time messaging session, where the recorded voice messages comprise recorded voice notes.

26. The emergency management cloud server of claim 1, further configured to:
play an audio file of a recorded voice message from the user device at the ESP terminal during the real time messaging session.

27. The emergency management cloud server of claim 1, further configured to:
receive an emergency alert from a monitoring center on behalf of a user of the user device.

28. The emergency management cloud server of claim 27, further configured to:
initiate the real time messaging session as a three-way real time chat between the user device, the monitoring center, and the ESP terminal.

29. A method for facilitating communications between a user in an emergency and an emergency service provider (ESP), by an emergency management cloud server, the method comprising:
identifying a user in an emergency, the user associated with a user device;
obtaining a location of the emergency, the location generated by the user device;
determining an ESP, from a plurality of ESPs, that can provide an emergency response to the location based on the location being within a service area of the ESP;
providing a prompt at an ESP terminal to initiate communication with the user device via the emergency management cloud server;
receiving an input from the ESP terminal; and
initiating a real time messaging session between the user device and the ESP terminal.

30. The method of claim 29, further comprising:
initiating the real time messaging session in response to receiving a confirmation from the user device.

31. The method of claim 29, further comprising:
receiving a location confirmation from the user device; and
initiating the real time messaging session in response to receiving the location confirmation.

32. The method of claim 29, further comprising:
enabling the ESP terminal to terminate the real time messaging session; and
initiating a close of session protocol in response to termination.

33. The method of claim 29, further comprising:
displaying the real time messaging session to appear as a message type selected from a list of message types consisting of: a short-message-service (SMS) message exchange, a multi-media message service (MMS) message exchange, and a rich communication services (RCS) message exchange when the ESP corresponding to the ESP terminal does not have text-to-911 capability.

34. The method of claim 29, further comprising:
providing a status of the real time messaging session to the ESP terminal in an emergency queue, the status consisting of options: active and closed.

35. The method of claim 34, further comprising:
providing the status in the emergency queue in response to initiation of the real time messaging session.

36. The method of claim 34, further comprising:
removing an entry in the emergency queue corresponding to the real time messaging session in response to termination of the real time messaging session.

37. The method of claim 34, further comprising:
receiving an input from the ESP terminal; and
removing an entry in the emergency queue corresponding to the real time messaging session in response to the input.

38. The method of claim 29, further comprising:
re-initiating the real time messaging session between the ESP terminal and the user device by the ESP terminal.

39. The method of claim 29, further comprising:
providing an indication to the ESP terminal when a text-to-911 message is sent from a user device to an ESP corresponding to the ESP terminal, the indication configurable by the ESP terminal via an on-off toggle.

40. A processor, and a non-volatile, non-transitory memory operatively coupled to the processor and executable instructions stored in the non-volatile, non-transitory memory, executable by the processor, that when executed cause the processor to be operative to:
provide a graphical user interface (GUI) to an emergency service provider (ESP) terminal, the GUI operative to facilitate real time messaging between the ESP terminal and a user device during an emergency, the GUI comprising:
an emergency queue comprising emergency calls and emergency alerts received by the ESP;
a communication interface operative to send two-way messages and multimedia files during a real time messaging session; and
an interactive map depicting a location of an emergency and situational awareness information for responding to the emergency.

41. The processor, and a non-volatile, non-transitory memory of claim 40, wherein the processor is further operative to:
display the real time messaging session to appear as a message type selected from a list of message types consisting of: an short-message-service (SMS) message exchange, a multi-media message service (MMS) message exchange, and a rich communication services (RCS) message, when the ESP corresponding to the ESP terminal does not have text-to-911 capability.

42. The processor, and a non-volatile, non-transitory memory of claim 40, wherein the processor is further operative to:
provide a status of a real time messaging session in an emergency queue, the status selected from options consisting of: active and closed.

43. The processor, and a non-volatile, non-transitory memory of claim 40, wherein the processor is further operative to:
provide an indication of a real time messaging session in the emergency queue.

44. The processor, and a non-volatile, non-transitory memory of claim 40, wherein the processor is further operative to:
remove a real time messaging session from the emergency queue in response to termination of the real time messaging session.
